(19) United States
(12) Patent Application Publication
(10) Pub. No.: US 2024/0419610 A1
(43) Pub. Date: Dec. 19, 2024

(54) EMBEDDED CONTROL CIRCUIT, PERIPHERAL ACCESS METHOD, AND ELECTRONIC DEVICE

(71) Applicants: Chipsea Technologies (Shenzhen) Corp., Shenzhen (CN); Hefei Chipsea Electronics Technology Co., Ltd., Hefei (CN)

(72) Inventor: Shihao WANG, Hefei, Anhui (CN)

(73) Assignees: Chipsea Technologies (Shenzhen) Corp., Shenzhen (CN); Hefei Chipsea Electronics Technology Co., Ltd., Hefei (CN)

(21) Appl. No.: 18/816,069

(22) Filed: Aug. 27, 2024

Related U.S. Application Data
(63) Continuation-in-part of application No. PCT/CN2022/138404, filed on Dec. 12, 2022.

(30) Foreign Application Priority Data
Dec. 29, 2021 (CN) 202111647166.9

(51) Int. Cl. G06F 13/10

(52) U.S. Cl. CPC G06F 13/10; G06F 2213/40

(57) ABSTRACT

An embedded control circuit includes: a bus interface circuit for communicating with a host processor; a processor; one or more peripheral modules; a circuit system connected to the bus interface circuit; a first bus connected between the one or more peripheral modules and the circuit system; and a second bus connected between the one or more peripheral modules and the processor. The circuit system is configured to communicate with the host processor through the bus interface circuit and access the one or more peripheral modules via the first bus according to the command from the host processor, and the processor is configured to access the one or more peripheral modules via the second bus.

### CROSS-REFERENCE TO RELATED APPLICATIONS

This application is a Continuation of International Patent Application No. PCT/CN2022/138404 filed on Dec. 12, 2022, which claims the benefit of priority of Chinese Patent Application No. 202111647166.9 filed on Dec. 29, 2021. The contents of the above applications are incorporated by reference as if fully set forth herein in their entirety.

### TECHNICAL FIELD

The present disclosure relates to the technical field of electronic circuits, for example, an embedded control circuit, a peripheral access method, and an electronic device.

### BACKGROUND

Electronic devices such as personal computers manage at least some peripheral devices (referred to as peripherals) through an embedded controller (EC). The processor (referred to as the host processor) of the electronic device and the processor of the embedded controller need to access these peripherals. In the related art, no effective solution has been proposed as to how the processor of the embedded controller and the host processor can access the peripherals more efficiently, conveniently, and reliably.

### SUMMARY

In view of the above, embodiments of the present disclosure provide an embedded control circuit, a peripheral access method, and an electronic device.

According to an aspect of the present disclosure, an embedded control circuit is provided, which includes: a bus interface circuit for communicating with a host processor; a processor; one or more peripheral modules; a circuit system connected to the bus interface circuit; a first bus connected between the one or more peripheral modules and the circuit system; and a second bus connected between the one or more peripheral modules and the processor. The circuit system is configured to communicate with the host processor through the bus interface circuit and access the one or more peripheral modules via the first bus according to a command from the host processor, and the processor is configured to access the one or more peripheral modules via the second bus.

According to another aspect of the present disclosure, a peripheral access method applied to an embedded control circuit is provided. The embedded control circuit includes a bus interface circuit, a processor, one or more peripheral modules, and a circuit system. The peripheral access method includes: communicating, by the circuit system, with a host processor through the bus interface circuit and accessing the one or more peripheral modules via a first bus according to a command from the host processor, where the first bus is connected between the one or more peripheral modules and the circuit system; and accessing, by the processor, the one or more peripheral modules via a second bus, where the second bus is connected between the one or more peripheral modules and the processor.

According to another aspect of the present disclosure, a chip is provided, and the chip includes the embedded control circuit in embodiment of the present disclosure.

According to another aspect of the present disclosure, an electronic device is provided, and the electronic device includes the embedded control circuit in embodiment of the present disclosure or the chip in embodiment of the present disclosure.

### BRIEF DESCRIPTION OF THE DRAWINGS

FIG. 1 illustrates a schematic block diagram of an embedded control circuit based on shared interfaces in some exemplary embodiments of the present disclosure.

FIG. 2 illustrates a schematic block diagram of a peripheral module 130 in some exemplary embodiments of the present disclosure.

FIG. 3 illustrates a schematic block diagram of an embedded control circuit based on an enhanced serial peripheral interface (eSPI) bus and shared interfaces in some exemplary embodiments of the present disclosure.

FIG. 4 illustrates a schematic block diagram of an embedded control circuit using direct memory access in some exemplary embodiments of the present disclosure.

FIG. 5 illustrates a flowchart of a peripheral access method using direct memory access in some exemplary embodiments of the present disclosure.

FIG. 6 illustrates a schematic block diagram of a circuit system 440 in some exemplary embodiments of the present disclosure.

FIG. 7 illustrates a schematic block diagram of an embedded control circuit using an eSPI bus and direct memory access in some exemplary embodiments of the present disclosure.

FIG. 8 illustrates a schematic block diagram of a circuit system 740 in some exemplary embodiments of the present disclosure.

FIG. 9 illustrates a schematic block diagram of an embedded control circuit based on direct memory access and shared interfaces in some exemplary embodiments of the present disclosure.

FIG. 10 illustrates a flowchart of a peripheral access method based on direct memory access and shared interfaces in some exemplary embodiments of the present disclosure.

FIG. 11 illustrates a schematic block diagram of an embedded control circuit based on direct memory access and shared interfaces and using an eSPI bus in some exemplary embodiments of the present disclosure.

FIG. 12 illustrates a schematic block diagram of an embedded control circuit using dual bus interfaces in some exemplary embodiments of the present disclosure.

FIG. 13 illustrates a schematic block diagram of an embedded control circuit using low pin count (LPC)-eSPI dual bus interfaces in some exemplary embodiments of the present disclosure.

### DETAILED DESCRIPTION

It should be understood that the various steps documented in the method embodiments of the present disclosure may be performed in a different order and/or in parallel. Furthermore, the method embodiments may include additional steps and/or omit performing the illustrated steps. The scope of the present disclosure is not limited in this regard.

As used herein, the term “include” and variations thereof are intended to be inclusive, that is, “including, but not limited to”. The term “based on” is “based at least in part on”. The term “one embodiment” means “at least one embodiment”; the term “another embodiment” means “at least one other embodiment”; and the term “some embodiments” means “at least some embodiments”. Related definitions of other terms will be given in the following description. It should be noted that the concepts of “first”, “second” and the like mentioned in the present disclosure are only used to differentiate different devices, modules or units, and are not used to define the order or interdependence of the functions performed by these devices, modules or units.

It should be noted that, the modification “one” or “a plurality of” referred to in the present disclosure is meant to be illustrative and non-limiting, and should be construed as “one or more” unless otherwise expressly indicated in the context, as will be appreciated by those skilled in the art.

Some embodiments of the present disclosure relate to the integration of peripheral modules in an embedded controller and to improvements in the technical solutions for accessing the peripheral modules through the processor of the embedded controller and a host processor.

Some embodiments of the present disclosure relate to an embedded control circuit which is based on shared interfaces, and peripheral modules are integrated in the embedded control circuit. The peripheral modules each include two interfaces. For each peripheral module, a host processor accesses the peripheral module through a bus interface circuit and one interface of the peripheral module, and a processor of the embedded control circuit accesses the peripheral module through the other interface of the peripheral module. In some embodiments, at least one peripheral module each includes an interface unit for connecting a peripheral. In some embodiments, an interface unit that is used for connecting a peripheral and corresponds to one of at least one peripheral module, is independent of the peripheral module, and connected to the processor.

Some embodiments of the present disclosure relate to an embedded control circuit using direct memory access. Peripheral modules are integrated in the embedded control circuit, and a circuit system is provided in the embedded control circuit. A host processor accesses the peripheral modules through a bus interface circuit and the circuit system, and a processor of the embedded control circuit may access the peripheral modules through the lines between the processor and the peripheral modules. In the embodiments, when the peripheral modules are integrated in the embedded control circuit, the address of each peripheral module is opened to the host processor, and the host processor accesses the peripheral module using the address of the peripheral module without modifying the bus interface circuit, which facilitates integration of the peripheral modules in the embedded control circuit.

Some embodiments of the present disclosure relate to an embedded control circuit based on shared interfaces and direct memory access, and peripheral modules are integrated in the embedded control circuit. Some of the peripheral modules are peripheral modules including two interfaces, and the host processor may access each of these peripheral modules through a bus interface circuit and one interface of the peripheral module, and a processor of the embedded control circuit may access the peripheral module through the other interface of the peripheral module. Other peripheral modules are peripheral modules that allow direct memory access through a circuit system. The host processor accesses these peripheral modules through a bus interface circuit and the circuit system, and the processor of the embedded control circuit may access these peripheral modules.

Some embodiments of the present disclosure relate to a bus interface circuit of an embedded control circuit. The bus interface circuit may include interface circuits of at least two bus protocols, and a bus interface selection circuit selects one of the interface circuits of the at least two bus protocols to communicate with a host processor.

It should be understood that the “first bus”, “second bus”, “third bus”, “fourth bus” and the like referred to in the present disclosure only distinguish between transmission lines between different devices in some embodiments, and it is possible to utilize different buses or share at least part of the lines and interfaces by means of a bus matrix or the like, which are not limited in the present disclosure.

In subsequent descriptions of the present disclosure, embodiments of the present disclosure may be combined in any combination. Exemplary embodiments of the present disclosure will be described as follows.

Embodiments of the present disclosure provide an embedded control circuit based on shared interfaces.

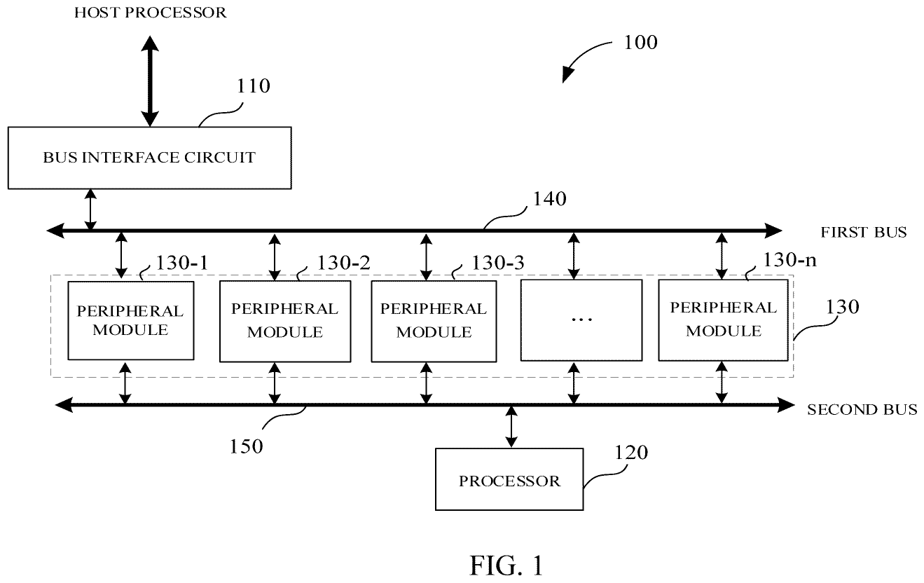

FIG. 1 illustrates a schematic block diagram of an embedded control circuit based on shared interfaces in some exemplary embodiments of the present disclosure. As shown in FIG. 1, the embedded control circuit 100 includes a bus interface circuit 110 for communicating with a host processor, a processor 120, peripheral modules 130, a first bus 140, and a second bus 150. FIG. 1 shows multiple peripheral modules 130, which are the peripheral modules labelled 130-1 to 130-n. The first bus 140 is connected between a first interface of each peripheral module 130 and the bus interface circuit 110, and the second bus 150 is connected between a second interface of each peripheral module 130 and the processor 120. The bus interface circuit 110 accesses the peripheral modules 130 via the first bus 140. The processor 120 accesses the peripheral modules 130 via the second bus 150. Since the host processor and the processor 120 use separate buses, the host processor and the processor 120 access the peripheral modules without interfering with each other, which can increase the bus bandwidth and improve the access speed. For example, the host processor accesses the peripheral module 130-1 via the first bus 140, and the processor 120 may access the peripheral module 130-n via the second bus 150 at the same time.

In the embodiments, it is possible to use various types of bus interfaces for communication with the host processor, including, but not limited to, a low pin count (LPC) bus, a serial peripheral interface (SPI) bus, an enhanced serial peripheral interface (eSPI) bus, and so on. The bus interface circuit 110 includes one or more bus interfaces. The bus interface circuit 110 is operable to use one of the bus interfaces for communication. The present embodiments are not limited thereto. In the embodiments, the bus interface circuit 110 may communicate with the host processor in accordance with a bus protocol. In an example, an eSPI bus may be used between the embedded control circuit 100 and the host processor. The embedded control circuit 100 serves as a slave device (eSPI slave) on the eSPI bus, the host processor serves as a master device (eSPI master) on the eSPI bus, and the bus interface circuit 110 may serve as an eSPI slave module. The present embodiments are not limited thereto.

In the embodiments, the first bus 140 may include any bus compatible with the bus interface circuit 110, and examples of the first bus 140 may include a local bus, an Advanced extensible Interface (AXI) bus, an advanced peripheral bus (APB), and the like, which are not limited by the embodiments.

In the embodiments, the second bus 150 may include any bus compatible with the processor 120, and examples of the second bus 150 may include a local bus, an Advanced extensible Interface (AXI) bus, an advanced peripheral bus (APB), and the like, which are not limited by the embodiments.

In the embodiments, the bus interface circuit 110 defines an input/output (I/O) interface corresponding to each peripheral module 130. In the disclosure, the interfaces may also be referred to as ports. In the disclosure, they are expressed uniformly as interfaces.

In the embodiments, the peripheral modules 130 may include part of the circuit modules of various peripheral devices, and examples of the peripheral devices include a mouse, a keyboard, a universal serial bus (USB), power delivery (PD)/Type-C, a breathing light, and an ambient light. The present embodiments are not limited thereto.

In some embodiments, the peripheral modules 130 each may include an interface unit for connecting a peripheral. In some embodiments, the peripheral module 130 includes the interface unit for connecting to the peripheral, the peripheral module 130 obtains data from the peripheral connected to the interface unit of the peripheral module 130 and/or provides data to the peripheral connected thereto, and communication between the peripheral module 130 and the host processor may not go through the processor 120. In the embodiments, the processor 120 may, via the second bus 150, perform read and/or write operations on the peripheral module 130, e.g., may read and/or write parameters configured for the peripheral module 130. The host processor may, via the bus interface circuit 110 and the first bus 140, perform read and/or write operations on the peripheral module 130. For example, the host processor may write data, which is to be sent by the peripheral connected to the peripheral module 130, to the peripheral module 130, read data, which is from the peripheral connected to the peripheral module 130, from the peripheral module 130, or configure parameters for the peripheral module 130. Examples of the peripheral module 130 including the interface unit for connecting to the peripheral include a serial interface module (e.g., a universal asynchronous receiver/transmitter (UART) serial port), the serial interface module includes an interface unit, and the interface unit is configured for connecting a serial communication physical interface (e.g., a UART connector). The serial interface module and the serial communication physical interface may adopt serial communication interface standards such as RS-232C, RS-422, RS-423, and RS-485.

In some embodiments, an interface unit that is used for connecting a peripheral and corresponds to the peripheral module 130, is independent of the peripheral module 130 and connected to the processor 120. The processor 120 may provide data from the peripheral module 130 to the interface unit corresponding to the peripheral module 130 or provide data from the interface unit to the peripheral module 130 corresponding to the interface unit. The host processor may provide data to the peripheral module 130. The data provided by the host processor to the peripheral module 130 may be provided, via the processor 120, to the interface unit corresponding to the peripheral module 130, and the processor 120 may provide the data in the interface unit to the peripheral module 130 corresponding to the interface unit. The host processor may obtain the data from the peripheral module 130. Generally, the processor 120 may be connected, via a fast bus or the like, to the interface unit independent of the peripheral module 130. Examples of the interface unit for connecting to the peripheral, which is independent of the peripheral module 130 and connected to the processor, include a keyboard interface unit. In an example, a keyboard controller in a keyboard detects the pressing and releasing of key(s) and transmits a keyboard code to the keyboard interface unit. The processor 120 detects that the keyboard interface unit receives the keyboard code, and the processor 120 provides the keyboard code to the peripheral module 130 corresponding to the keyboard interface unit.

In some embodiments, some of the peripheral modules 130 each include an interface unit for connecting to a peripheral, the peripheral module 130 obtains data from the peripheral connected to the interface unit of the peripheral module 130 and/or provides data to the peripheral connected thereto, and communication between the peripheral module 130 and the host processor may not go through the processor 120. Some of the peripheral modules 130 each correspond to an interface unit for connecting to a peripheral, and the interface unit is independent of the peripheral module 130 and connected to the processor 120. The processor 120 may provide data from the peripheral module 130 to the interface unit corresponding to the peripheral module 130 or provide data from the interface unit to the peripheral module 130 corresponding to the interface unit. The host processor may provide data to the peripheral module 130. The data provided by the host processor to the peripheral module 130 may be provided, via the processor 120, to the interface unit corresponding to the peripheral module 130, the processor 120 may provide the data in the interface unit to the peripheral module 130 corresponding to the interface unit, and the host processor may obtain the data from the peripheral module 130.

In an example, the peripheral module 130 includes a keyboard module and a serial interface module. An interface unit (referred to as a keyboard interface unit) of the keyboard module is independent of the keyboard module, and the keyboard interface unit is connected to the processor 120. The serial interface module includes an interface unit for connecting a serial communication physical interface.

In the example, the serial interface module receives data sent by the host processor through the bus interface circuit 110, and transmits the data via the serial communication physical interface; data is received via the serial communication physical interface, the data received via the serial communication physical interface of the serial interface module is sent to the host processor through the bus interface circuit 110, and the data is not processed by the processor 120. The processor 120 may configure the serial interface module via the second bus 150; alternatively, the host processor may configure the serial interface module via the bus interface circuit 110 and the first bus 140.

In the example, the processor 120 may provide data from the keyboard module to the keyboard interface unit or provide data from the keyboard interface unit to the keyboard module. The host processor may provide data to the keyboard module, and the data provided by the host processor to the keyboard module may be provided to the keyboard interface unit via the processor 120; the processor 120 may provide the data in the keyboard interface unit to the keyboard module 130, and the host processor may obtain the data from the keyboard module 130. For example, a keyboard code is obtained by the processor 120 from the keyboard interface unit, the keyboard code is provided to the keyboard module, and the host processor reads the keyboard code from the keyboard module through the bus interface circuit 110.

In some embodiments, the bus interface circuit 110 is configured to receive a write command from the host processor and write, via the first bus 140, data into a register of the peripheral module 130 corresponding to the write command. In some embodiments, the bus interface circuit 110 is configured to receive a read command from the host processor and read, via the first bus 140, data from a register of the peripheral module 130 corresponding to the read command.

In some embodiments, the processor 120 is configured to read data from a register of the peripheral module 130 via the second bus 150. In some embodiments, the processor 120 is configured to write data into a register of the peripheral module 130 via the second bus 150.

In some embodiments, the peripheral module 130 communicates with the peripheral via the processor 120. The processor 120 is configured to receive inputs from the peripheral, and write, via the second bus 150, data into the register of the peripheral module 130 corresponding to the peripheral based on the received inputs.

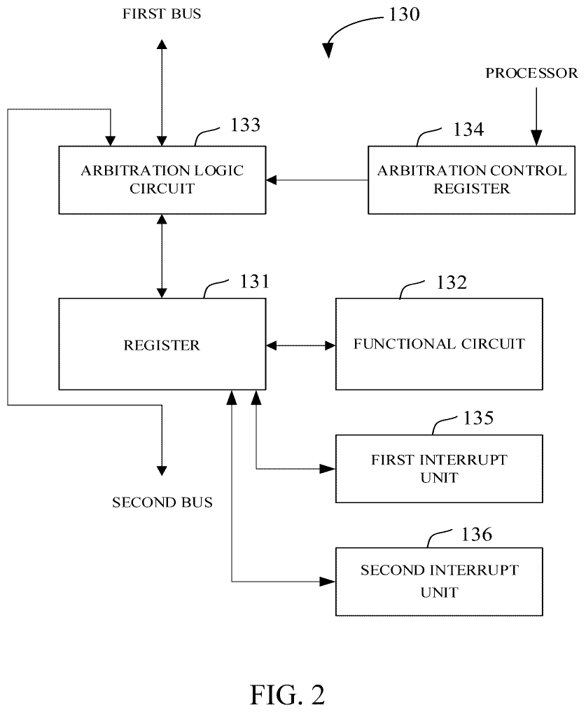

In some embodiments, as shown in FIG. 2, the peripheral module 130 may include one or more registers 131, the processor 120 performs (via the second bus 150) read and/or write operations on the one or more registers 131, and the host processor performs (via the bus interface circuit 110 and the first bus 140) read and/or write operations on the one or more registers 131. The processor 120 performs, via the second interface of the peripheral module 130, read and/or write operations on the one or more registers 131 of the peripheral module 130. The bus interface circuit 110 performs, via the first interface of the peripheral module 130, read and/or write operations on the one or more registers 131 of the peripheral module 130. The one or more registers 131 may be provided in the peripheral module 130 based on its function, and examples of the register(s) 131 of the peripheral module 130 may include a configuration register, a status register, a control register, a read data register or a write data register.

In some embodiments, as shown in FIG. 2, the peripheral module 130 may include one or more functional circuits 132, and the one or more functional circuits 132 work with the peripheral to implement the functions of the peripheral. Examples of the peripheral module 130 include a serial interface module for connecting a serial communication physical interface. The functional circuit of the serial interface module includes a level shifting circuit, and the level shifting circuit performs level shifting based on a serial communication interface standard. Another example of the peripheral module 130 includes a light-emitting unit control module, and the light-emitting unit control module is used for connecting one or more light-emitting units (e.g., light-emitting diodes). The functional circuit of the light-emitting unit control module may include a controller, and the controller controls the one or more light-emitting units to cmit light.

In some embodiments, as shown in FIG. 2, the peripheral module 130 includes an arbitration logic circuit 133, and the arbitration logic circuit 133 is connected to the first bus 140 and the second bus 150 separately. The arbitration logic circuit 133 is configured to arbitrate access requests from the processor 120 and the host processor (through the bus interface circuit 110).

In some embodiments, as shown in FIG. 2, the arbitration logic circuit 133 is configured to connect to an arbitration control register 134 such that an arbitration policy is provided to the arbitration logic circuit 133. In some embodiments, the processor 120 is further connected to the arbitration control register 134 to write the arbitration policy into the arbitration control register 134. In an example, the arbitration control register 134 is outside of the peripheral module 130, which is not limited in the embodiments.

In some embodiments, when the peripheral module 130 is accessed by the host processor, the arbitration logic circuit 133 disconnects the second interface of the peripheral module 130 from the second bus 150. In some embodiments, when the peripheral module 130 is accessed by the processor 120, the arbitration logic circuit 133 disconnects the first interface of the peripheral module 130 from the first bus 140. Required arbitration for every access from the host processor and processor 120 can be avoided, and efficiency and potential functionality issues associated with a single bus due to complex arbitration logic can be avoided.

In some embodiments, when the peripheral module 130 is released by the host processor, the arbitration logic circuit 133 connects the second interface of the peripheral module 130 to the second bus 150. In some embodiments, when the peripheral module 130 is released by the processor 120, the arbitration logic circuit 133 connects the first interface of the peripheral module 130 to the first bus 140.

The peripheral module 130 transmits at least partial information to the processor 120 and/or the host processor (through the bus interface circuit 110) by means of interrupts.

In some embodiments, as shown in FIG. 2, the peripheral module 130 further includes a first interrupt unit 135. The first interrupt unit 135 may be configured to transmit write-related interrupt information. This is not limited in the embodiments.

In some embodiments, the first interrupt unit 135 is configured to: transmit, after the processor 120 writes data into the register 131 of the peripheral module 130, first interrupt information to the bus interface circuit 110. The bus interface circuit 110 transmits the first interrupt information to the host processor, and may perform, in response to a command from the host processor, read and/or write operations on the register 131 of the peripheral module 130. And/or, the first interrupt unit 135 is configured to: transmit, after the host processor writes data into the register 131 of the peripheral module 130, second interrupt information to the processor 120. In response to the second interrupt information, the processor 120 may perform read and/or write operations on the register 131 of the peripheral module 130.

In an alternative embodiment, the first interrupt unit 135 is configured to: transmit, after the peripheral connected to the register 131 of the peripheral module 130 writes data into the register 131 of the peripheral module 130, first interrupt information to the bus interface circuit 110. The bus interface circuit 110 transmits the first interrupt information to the host processor, and may perform, in response to a command from the host processor, read and/or write operations on the registers 131 of the peripheral module 130. In some instances, after the host processor writes data into the register 131 of the peripheral module 130, the peripheral module 130 transmits the data to the peripheral connected thereto.

In some embodiments, as shown in FIG. 2, at least one peripheral module 130 further includes a second interrupt unit 136. The second interrupt unit 136 may be configured to transmit read-related interrupt information. This is not limited in the embodiments.

In some embodiments, the second interrupt unit 136 is configured to transmit, after data in the register 131 of the peripheral module 130 that has been written by the host processor is read by the processor 120, third interrupt information to the host processor. And/or, the second interrupt unit 136 is configured to transmit, after data in the register 131 of the peripheral module 130 that has been written by the processor 120 is read by the host processor, fourth interrupt information to the processor 120.

In some embodiments, the processor 120 is configured to: detect whether data has been written into the register of the peripheral module 130 by the host processor; and, when it is determined that the data has been written into the register of the peripheral module 130 by the host processor, read the data from the register of the corresponding peripheral module 130 via the second bus 150. In some instances, the processor 120 may transmit the read data to a peripheral interface unit that is connected to the processor 120 and corresponds to the peripheral module.

In some embodiments, the bus interface circuit 110 is further configured to set, after data has been read from the register of the peripheral module 130, a first flag bit corresponding to the register of the peripheral module 130 to “read”. In some embodiments, the processor 120 is further configured to query the first flag bit of the register of the peripheral module 130 and determine, based on the first flag bit, whether the data in the register of the corresponding peripheral module 130 has been read by the host processor.

The following is a description of an embedded control circuit based on shared interfaces in some exemplary embodiments of the present disclosure, where an eSPI bus is used as an example, and the host processor communicates with the embedded control circuit via the eSPI bus.

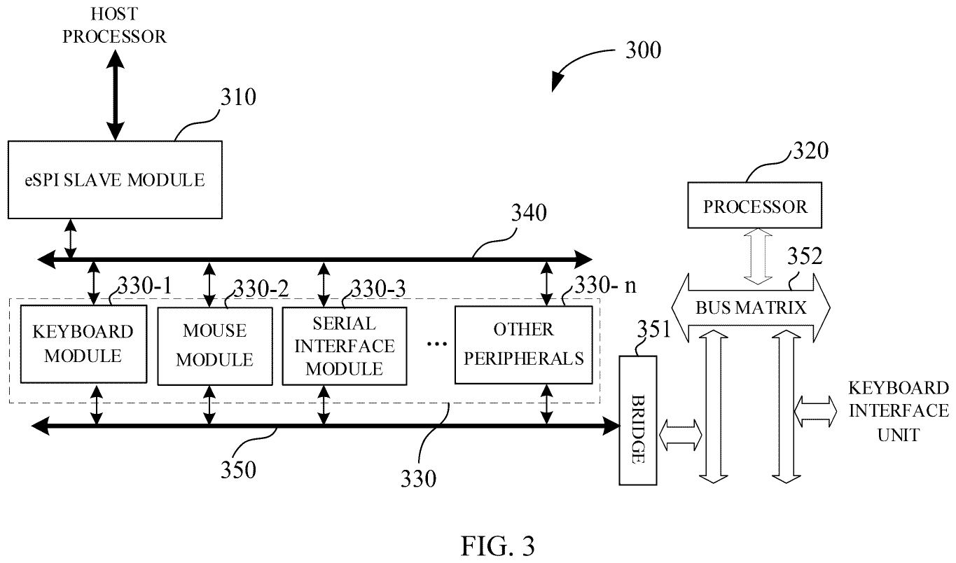

FIG. 3 illustrates a schematic block diagram of an embedded control circuit based on an eSPI bus and shared interfaces in some exemplary embodiments of the present disclosure. As shown in FIG. 3, the embedded control circuit 300 includes an eSPI slave module 310 for communicating with a host processor, a processor 320, a peripheral module 330, a first bus 340, and a second bus 350. Multiple peripheral modules 330 are illustrated in FIG. 3 and include a keyboard module 330-1, a mouse module 330-2, a serial interface module 330-3, and other peripherals 330-n. The first bus 340 is connected between the eSPI slave module 310 and first interfaces of the keyboard module 330-1, the mouse module 330-2, the serial interface module 330-3, and the other peripherals 330-n. The second bus 350 is connected between second interfaces of the peripheral modules 330 and the processor 320. The eSPI slave module 310 accesses the peripheral modules 330 via the first bus 340. The processor 320 accesses the peripheral module 330 via the second bus 350.

The embedded control circuit 300 manages peripherals through an eSPI interface between the host processor and the embedded control circuit 300 and through an IO interface (which is defined on the eSPI slave module and is an address accessible to the host processor) that is located on the embedded control circuit 300 and accessible to the host processor.

In the embodiments, the keyboard module 330-1, the mouse module 330-2, the serial interface module 330-3, and the other peripherals such as the peripheral 330-n each have two interfaces, and the two interfaces are connected to the first bus 340 (e.g., local bus 1) and the second bus 350 (e.g., local bus 2), respectively. The read/write operations from the first bus 340 and the second bus 350 on registers are arbitrated by accessing an arbitration logic circuit. An arbitration policy (selection priority) is selected by an arbitration control register. The arbitration control is upon an arbitration control register outside of the module, and the arbitration control register is configured by the processor 320.

In the embodiments, as shown in FIG. 3, the connection is made using a bus matrix 352. The processor 320 is connected to the bus matrix 352, the second bus 350 is connected to the bus matrix 352 (via a bridge 351), the second bus 350 is connected to the second interface of the peripheral module 330, and thus the processor 320 accesses the peripheral module 330 via the bus matrix 352 and the second bus 350. An interface unit (e.g., a keyboard interface unit) corresponds to the peripheral module 330 and is independent of the peripheral module 330, the interface unit is connected to the processor 320, the interface unit is connected to the bus matrix 352 via a bus such as a fast bus, and thus the processor 320 communicates with the interface unit via the bus matrix 352 and the associated bus.

Taking a serial interface as an example, the register of the serial interface module 330-3 has two interfaces, one interface is connected to the host processor through the first bus 340 such that the host processor can configure or operate the serial interface through the interface, and the other interface is connected to the processor 320 through the second bus 350 such that the processor 320 of the embedded control circuit 300 can configure and access the serial interface through the other interface. When the host processor and the processor 320 configure or operate the register of the serial interface through the two different interfaces simultaneously, an access arbitration mechanism gives either the host processor or gives the processor 320 higher access priority based on the configuration.

Examples of the working process of the serial interface are described below. The serial interface module 330-3 obtains data from the peripheral connected to the interface unit of the serial interface module 330-3 and/or provides data to the peripheral connected thereto, and communication between the serial interface module 330-3 and the host processor may not go through the processor 120. The host processor performs read and/or write operations on the serial interface module 330-3. For example, the host processor writes data, which is to be sent by the peripheral connected to the serial interface module 330-3, to the serial interface module 330-3, or reads data, which is from the peripheral connected to the serial interface module 330-3, from the serial interface module 330-3, or configures parameters for the serial interface module 330-3.

Examples of the working process of a keyboard are described below. A keyboard interface unit corresponding to the keyboard module 330-1 is independent of the keyboard module 330-1, and is connected to the processor 320. A computer operator presses a key of the keyboard, the processor 320 obtains the keyboard code corresponding to the keyboard key action through the keyboard interface unit, and the keyboard code is written into a register within the keyboard module 330-1 through the bus matrix 352, the bridge 351, and the second bus 350. The keyboard module 330-1 generates an interrupt through the eSPI slave module 310 and the interrupt is reported to the host processor. The host processor receives the interrupt, initiates a read operation to read the keyboard code value from the register of the keyboard module 330-1, sets a flag bit to “the code value has been read”, and clears the corresponding register. The keypad module 330-1 generates an interrupt to notify the processor 320 that the host processor has read the keypad code value. If the interrupt is not used, the processor 320 may query a status flag bit of the keyboard module 330-1 to determine whether the keyboard code value has been read by the host processor.

Embodiments of the present disclosure provide an embedded control circuit using direct memory access.

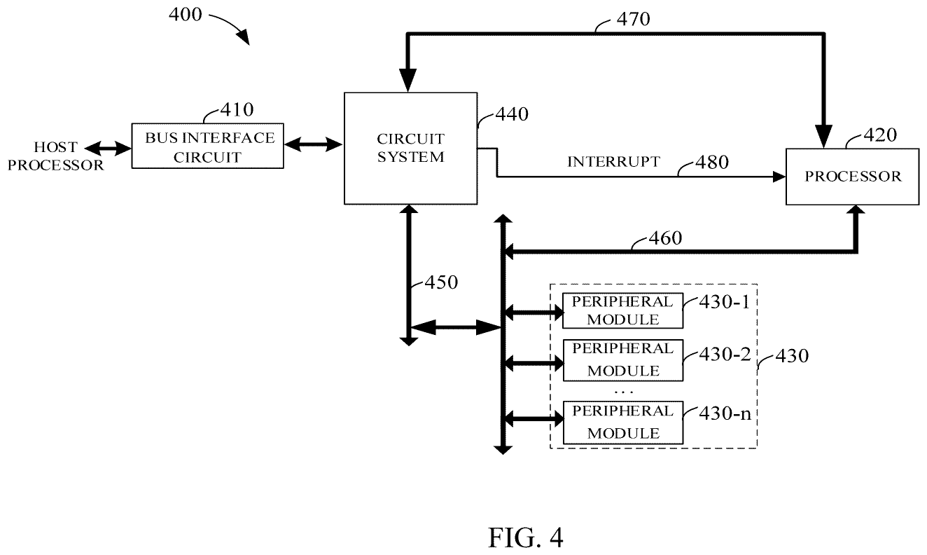

FIG. 4 illustrates a schematic block diagram of an embedded control circuit using direct memory access in some exemplary embodiments of the present disclosure. As shown in FIG. 4, the embedded control circuit 400 includes a bus interface circuit 410 for communicating with a host processor, a processor 420, one or more peripheral modules 430, a circuit system 440, a first bus 450, and a second bus 460. In the embodiments, the embedded control circuit may include one or more peripheral modules 430. For example, as illustrated in FIG. 4, peripheral modules 430-1 through 430-n are provided.

As shown in FIG. 4, the circuit system 440 is connected to the bus interface circuit 410. The first bus 450 is connected between the peripheral modules 430 and the circuit system 440, and the second bus 460 is connected between the peripheral modules 430 and the processor 420. The circuit system 440 communicates with the host processor through the bus interface circuit 410 and accesses the peripheral modules 430 via the first bus 450 according to commands from the host processor. The processor 420 is configured to access the peripheral modules 430 via the second bus 460. In the embodiments, the bus interface circuit 410 may not define an I/O interface corresponding to each peripheral module 430, the circuit system 440 is configured to access the peripheral modules 430 via the first bus 450 based on commands from the host processor, and thus integrating (e.g., adding) the peripheral modules 430 in the embedded control circuit may be done without adjusting the bus interface circuit.

In the embodiments, the circuit system 440 accessing the peripheral modules 430 may adopt direct memory access (DMA) commands.

In the embodiments, various types of bus interfaces may be used to communicate with the host processor, including, but not limited to, an LPC bus, an SPI bus, an eSPI bus, and so on. The bus interface circuit 410 includes one bus interface or multiple bus interfaces. The bus interface circuit 410 is operable to use one of the multiple bus interfaces for communication. The present embodiments are not limited thereto. In the embodiments, the bus interface circuit 410 may communicate with the host processor in accordance with a bus protocol. In an example, an eSPI bus may be used between the embedded control circuit 400 and the host processor. The embedded control circuit 400 serves as a slave device (eSPI slave) on the eSPI bus, the host processor serves as a master device (eSPI master) on the eSPI bus, and the bus interface circuit 410 may serve as an eSPI slave module. The present embodiments are not limited thereto.

In the embodiments, the first bus 450 may include any bus compatible with the peripheral modules 430 and the circuit system 440, examples of the first bus 450 may include a local bus, an AXI bus, an APB, and an advanced high-performance bus (AHB) among others, and the embodiments do not limit this. In the embodiments, the circuit system 440 may serve as a master device (master) of the first bus 450 and the peripheral modules 430 may serve as slave devices (slaves) of the first bus 450. The peripheral modules 430 may respond to various bus commands from the circuit system 440.

In the embodiments, the second bus 460 may include any bus compatible with the peripheral module 430 and the processor 420, examples of the second bus 460 may include a local bus, an AXI bus, an APB, and an AHB among others, and the embodiments do not limit this. In the embodiments, the processor 420 may serve as a master device (master) of the second bus 460 and the peripheral modules 430 may serve as slave devices (slaves) of the second bus 460. The peripheral modules 430 may respond to various bus commands from the processor 420.

In some embodiments, the embedded control circuit 400 may use a bus matrix, through which the circuit system 440, the processor 420, and the peripheral modules 430 may access (or be accessed) in parallel, thereby improving access efficiency and reducing power consumption.

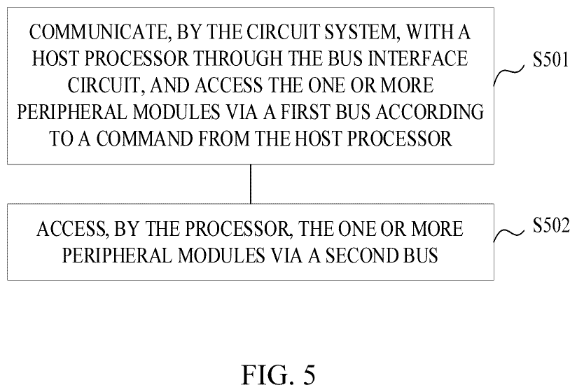

In the embodiments, the circuit system 440 is capable of communicating with the host processor through the bus interface circuit 410, and accessing the peripheral modules 430 via the first bus 450 according to commands from the host processor; and the processor 420 is capable of accessing the peripheral modules 430 via the second bus 460. FIG. 5 illustrates a flowchart of a peripheral access method using direct memory access in some exemplary embodiments of the present disclosure, and as shown in FIG. 5, the peripheral access method includes step S501 and step S502. At step S501, the circuit system 440 communicates with the host processor through the bus interface circuit 410 and accesses one or more of the peripheral modules 430 via the first bus 450 according to commands from the host processor. At step S502, the processor 420 accesses the one or more peripheral modules 430 via the second bus 460.

In some embodiments, at step S502, the processor 420 writes data into the registers of the peripheral modules 430 via the second bus 460. In some embodiments, at step S502, the processor 420 reads data from the registers of the peripheral modules 430 via the second bus 460.

In some embodiments, the circuit system 440 is configured to receive a write command from the host processor through the bus interface circuit 410 and write, based on the write command, data into the register of the peripheral module 430 corresponding to the write command via the first bus 450. In some embodiments, at step S501, the circuit system 440 receives the write command from the host processor through the bus interface circuit 410 and writes, based on the write command, data into the register of the peripheral module 430 corresponding to the write command via the first bus 450.

In some embodiments, the circuit system 440 is configured to receive a read command from the host processor through the bus interface circuit 410, and read, based on the read command, data from the register of the peripheral module 430 corresponding to the read command via the first bus 450. In some embodiments, at step S501, the circuit system 440 receives a read command from the host processor through the bus interface circuit 410, and reads, based on the read command, data from the register of the peripheral module 430 corresponding to the read command via the first bus 450.

In some embodiments, as shown in FIG. 4, the embedded control circuit 400 further includes a third bus 470, and the third bus 470 is connected between the processor 420 and the circuit system 440. Information may be transmitted between the circuit system 440 and the processor 420 via the third bus 470, and examples of the information may include configuration of the circuit system 440 from the processor 420 and interrupt information about the peripheral module 430 which is sent by the processor 420 to the host processor, which are not limited by the embodiments. In some embodiments, the processor 420 may serve as a master device (master) of the third bus 470 and the circuit system 440 may serve as a slave device (slave) of the third bus 470. The circuit system 440 may respond to various bus commands from the processor 420.

In some embodiments, as shown in FIG. 4, the embedded control circuit 400 further includes an interrupt signal line 480, and the interrupt signal line 480 is connected between the processor 420 and the circuit system 440. The interrupt signal line 480 may be configured to transmit any interrupt signal between the processor 420 and the circuit system 440, which is not limited by the embodiments. In some embodiments, the circuit system 440 is configured to transmit an interrupt signal to the processor 420 via the interrupt signal line 480.

In some embodiments, the circuit system 440 is configured to access the peripheral modules 430 based on preset permissions. In the embodiments, each destination address may be configured to allow read and write access, allow read access and prohibit write access, or allow write access and prohibit read access, and the embodiments are not limited thereto. In some embodiments, the processor 420 configures, via the third bus 470, the permission for the circuit system 440 to access the peripheral modules 430. The circuit system 440 is configured to access the peripheral modules 430 based on permission information configured by the processor 420.

In some embodiments, the circuit system 440 is configured to access the peripheral modules 430 based on preset permissions, and in the case where the register of the peripheral module 430 accessed by the host processor is configured to prohibit access, the circuit system 440 transmits an interrupt signal to the processor 420 via the interrupt signal line 480 to notify the processor 420 that the host processor is requesting access to the register that prohibits access.

In some embodiments, an example of writing data into one of the peripheral modules 430 under permission control is illustrated below. The bus interface circuit 410 receives a write command from the host processor and transmits the write command to the circuit system 440. The circuit system 440 receives the write command and parses the write command to obtain a destination address and to-be-written data. The circuit system 440 determines whether the destination address is an address that allows write access, and in the case where the destination address is an address that allows write access, the circuit system 440 writes, via the first bus 450, the above data into the register of the peripheral module 430 corresponding to the destination address. In some examples, in the case where the destination address is an address that prohibits write access, the circuit system 440 transmits an interrupt signal to the processor 420 via the interrupt signal line 480 to notify the processor 420 that the host processor is requesting access to the register that prohibits write access.

In some embodiments, an example of reading data from one of the peripheral modules 430 under permission control is illustrated below. The bus interface circuit 410 receives a read command from the host processor and transmits the read command to the circuit system 440. The circuit system 440 receives the read command and parses the read command to obtain a destination address. The circuit system 440 determines whether the destination address is an address that allows read access. In the case that the destination address is an address that allows read access, the circuit system 440 reads, via the first bus 450, data from the register of the peripheral module 430 corresponding to the destination address. After the circuit system 440 reads the data, the circuit system 440 generates a bus command corresponding to the read command and transmits the bus command to the bus interface circuit 410. The bus interface circuit 410 transmits the bus command to the host processor so that the host processor receives the bus command to obtain the read data. In some examples, in the case where the destination address is an address that prohibits read access, the circuit system 440 transmits an interrupt signal to the processor 420 via the interrupt signal line 480 to notify the processor 420 that the host processor is requesting access to the register that prohibits read access.

In some embodiments, the processor 420 transmits interrupt information about the peripheral module 430 to the circuit system 440 via the third bus 470. Further, the circuit system 440 transmits the interrupt information to the host processor through the bus interface circuit 410.

In some embodiments, an example of the processor 420 transmitting interrupt information about the peripheral module 430 to the host processor is illustrated below. The processor 420 detects interrupt information about the peripheral module 430. The processor 420 transmits the detected interrupt information to the circuit system 440 via the third bus 470. The circuit system 440 generates a bus command corresponding to the interrupt information and transmits the generated bus command to the bus interface circuit 410. The bus interface circuit 410 transmits the bus command to the host processor so that the host processor receives the bus command to obtain the interrupt information. In some examples, after the host processor has obtained the interrupt information, the host processor responds to the embedded control circuit based on the interrupt information. In some examples, the host processor initiates, based on the interrupt information, a process of writing data into the register of the peripheral module 430 corresponding to the interrupt information. In some examples, the host processor initiates, based on the interrupt information, a process of reading data from the register of the peripheral module 430 corresponding to the interrupt information.

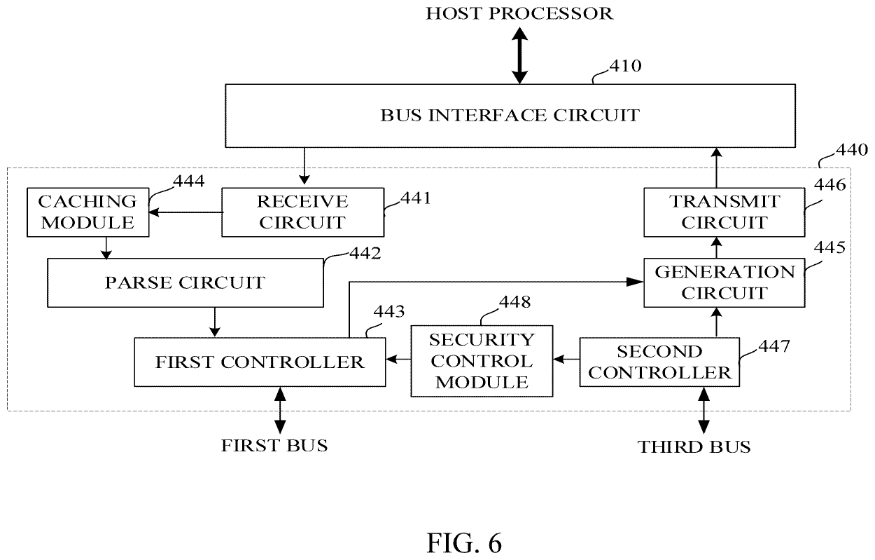

FIG. 6 illustrates a schematic block diagram of a circuit system 440 in some exemplary embodiments of the present disclosure. As shown in FIG. 6, the circuit system 440 includes: a receive circuit 441, configured to receive a bus command sent by the bus interface circuit 410; a parse circuit 442, connected to the receive circuit 441 and configured to parse the received bus command to obtain a destination address; and a first controller 443, connected to the parse circuit 442 and configured to access the register of the peripheral module 430 corresponding to the destination address. In the embodiments, the parse circuit 442 parses the bus command according to the bus interface protocol used by the bus interface circuit 410.

In some embodiments, the bus command includes a write command, the parse circuit 442 parses the bus command to also obtain target data, and the destination address is a to-be-written address. The first controller 443 is configured to write the target data into the register of the peripheral module 430 corresponding to the destination address.

In some embodiments, an example of writing data into one of the peripheral modules 430 is illustrated below. The bus interface circuit 410 receives a write command from the host processor and transmits the write command to the receive circuit 441. The receive circuit 441 receives the write command and transmits the write command to the parse circuit 442. The parse circuit 442 parses the write command to obtain a destination address and to-be-written data. The first controller 443 writes the above data into the register of the peripheral module 430 corresponding to the destination address via the first bus 450.

In some embodiments, the bus command includes a read command, the parse circuit 442 parses the bus command to obtain a destination address, and the destination address is a to-be-read address.

In some embodiments, as shown in FIG. 6, the circuit system 440 further includes a caching module 444, the caching module 444 is connected between the receive circuit 441 and the parse circuit 442, and the caching module 444 is configured to cache the received bus command to cause the parse circuit 442 to parse the bus command.

In some embodiments, an example of writing data into one of the peripheral modules 430 is illustrated below. The bus interface circuit 410 receives a write command from the host processor and transmits the write command to the receive circuit 441. The receive circuit 441 receives the write command, and the receive circuit 441 caches the write command to the caching module 444. The parse circuit 442 obtains the write command from the caching module 444, and the parse circuit 442 parses the write command to obtain a destination address and to-be-written data. The first controller 443 writes the above data into the register of the peripheral module 430 corresponding to the destination address via the first bus 450.

In some embodiments, as shown in FIG. 6, the circuit system 440 further includes: a generation circuit 445, configured to generate a bus command; and a transmit circuit 446, connected to the generation circuit 445 and configured to transmit the bus command generated by the generation circuit 445 to the bus interface circuit 410 to cause the generated bus command to be received by the host processor.

In some implementations, the first controller 443 is further configured to transmit data read from a destination address to the generation circuit 445 to cause the generation circuit 445 to generate a corresponding bus command, and the transmit circuit 446 transmits the generated bus command to the bus interface circuit 410.

In some embodiments, an example of reading data from one of the peripheral modules 430 is illustrated as follows. The bus interface circuit 410 receives a read command from the host processor and transmits the read command to the receive circuit 441. The receive circuit 441 receives the read command and transmits the read command to the parse circuit 442. The parse circuit 442 parses the read command to obtain a destination address. The first controller 443 reads data from the register of the peripheral module 430 corresponding to the destination address via the first bus 450. The first controller 443 transmits the read data to the generation circuit 445. The generation circuit 445 generates a bus command corresponding to the read command and transmits the bus command to the transmit circuit 446. The transmit circuit 446 transmits the bus command to the bus interface circuit 410. The bus interface circuit 410 transmits the bus command to the host processor so that the host processor receives the bus command to obtain the read data.

In some embodiments, as shown in FIG. 6, the circuit system 440 further includes a second controller 447 configured to receive information sent by the processor 420 via the third bus 470.

In some embodiments, the second controller 447 is further configured to receive interrupt information sent by the processor 420 via the third bus 470, and transmit the interrupt information to the generation circuit 445 to cause the generation circuit 445 to generate a corresponding bus command. The transmit circuit 446 transmits the generated bus command to the bus interface circuit 410 to cause the bus interface circuit 410 to transmit the interrupt information to the host processor.

In some embodiments, an example of the processor 420 transmitting interrupt information about one of the peripheral modules 430 to the host processor is illustrated below. The processor 420 detects interrupt information about the peripheral module 430. The processor 420 transmits the detected interrupt information to the generation circuit 445 via the third bus 470. The generation circuit 445 generates a bus command corresponding to the interrupt information. The transmit circuit 446 transmits the bus command generated by the generation circuit 445 to the bus interface circuit 410. The bus interface circuit 410 transmits the bus command to the host processor so that the host processor receives the bus command to obtain the interrupt information. In some examples, after the host processor has obtained the interrupt information, the host processor responds to the embedded control circuit based on the interrupt information. In some examples, the host processor initiates, based on the interrupt information, a process of writing data into the register of the peripheral module 430 corresponding to the interrupt information. In some examples, the host processor initiates, based on the interrupt information, a process of reading data from the register of the peripheral module 430 corresponding to the interrupt information.

In some embodiments, the circuit system 440 further includes a security control module 448, connected to the first controller 443 and the second controller 447. The security control module 448 is configured to provide permission information. The first controller 443 is further configured to determine the permission to access a destination address based on the permission information in the security control module 448. In some embodiments, the second controller 447 is further configured to receive permission information sent by the processor 420 via the third bus 470, and write the permission information into the security control module 448. In the embodiments, each destination address may be configured to allow read and write access, allow read access and prohibit write access, or allow write access and prohibit read access, and the embodiments are not limited thereto.

In some embodiments, an example of writing data into one of the peripheral modules 430 under permission control is illustrated as follows. The bus interface circuit 410 receives a write command from the host processor and transmits the write command to the receive circuit 441. The receive circuit 441 receives the write command and transmits the write command to the parse circuit 442; and as an example, the receive circuit 441 may cache the write command to the caching module 444, and the parse circuit 442 obtains the write command from the caching module 444. The parse circuit 442 parses the write command to obtain a destination address and to-be-written data. The first controller 443 determines whether the destination address is an address that allows write access, and in the case where the destination address is an address that allows write access, the first controller 443 writes the above data into the register of the peripheral module 430 corresponding to the destination address via the first bus 450. In some examples, the first controller 443 may access the security control module 448, obtain permission information from the security control module 448, and determine, based on the permission information, whether the destination address is an address that allows write access. In some examples, in the case where the destination address is an address that prohibits write access, the first controller 443 transmits an interrupt signal to the processor 420 via the interrupt signal line 480 to cause the processor 420 to be notified that the host processor is requesting to write data into the address that prohibits write access.

In some embodiments, an example of reading data from one of the peripheral modules 430 under permission control is illustrated below. The bus interface circuit 410 receives a read command from the host processor and transmits the read command to the receive circuit 441. The receive circuit 441 receives the read command and transmits the read command to the parse circuit 442; and in some examples, the receive circuit 441 caches the read command to the caching module 444, and the parse circuit 442 obtains the read command from the caching module 444. The parse circuit 442 parses the read command to obtain a destination address. The first controller 443 determines whether the destination address is an address that allows read access; and in some examples, the first controller 443 accesses the security control module 448, obtains permission information from the security control module 448, and determines, based on the permission information, whether the destination address is an address that allows read access. In the case where the destination address is an address that allows read access, the first controller 443 reads data from the register of the peripheral module 430 corresponding to the destination address via the first bus 450. The first controller 443 transmits the read data to the generation circuit 445. The generation circuit 445 generates a bus command corresponding to the read command and transmits the bus command to the transmit circuit 446. The transmit circuit 446 transmits the bus command to the bus interface circuit 410. The bus interface circuit 410 transmits the bus command to the host processor so that the host processor receives the bus command to obtain the read data. In some examples, in the case where the destination address is an address that prohibits read access, the first controller 443 transmits an interrupt signal to the processor 420 via the interrupt signal line 480 to cause the processor 420 to be notified that the host processor is requesting to read data from the address that prohibits read access.

The following is a description of an embedded control circuit using direct memory access in some exemplary embodiments of the present disclosure, where an eSPI bus is used as an example, and the host processor communicates with the embedded control circuit via the eSPI bus.

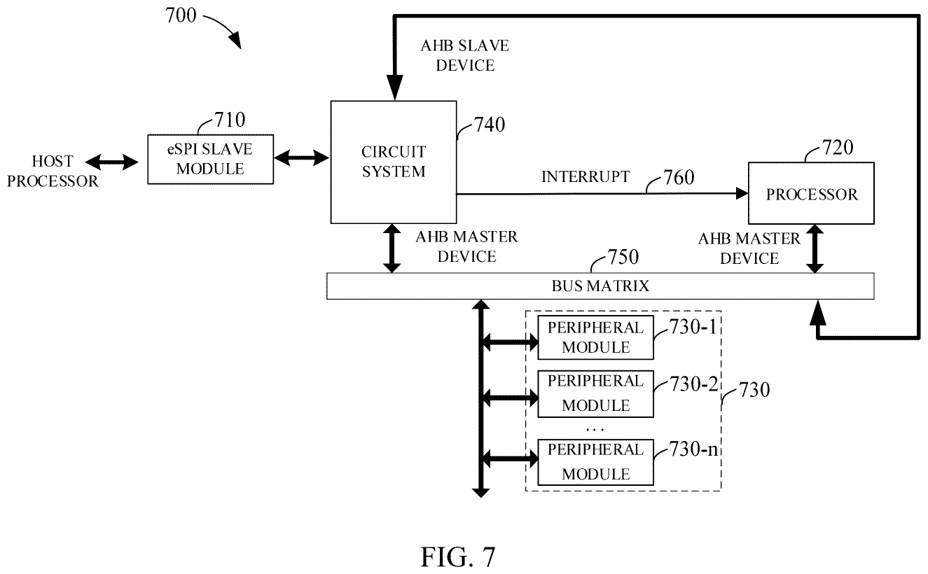

FIG. 7 illustrates a schematic block diagram of an embedded control circuit using an eSPI bus and direct memory access in some exemplary embodiments of the present disclosure. As shown in FIG. 7, the embedded control circuit 700 includes an eSPI slave module 710 for communicating with a host processor, a processor 720, one or more peripheral modules 730, and a circuit system 740. In the embodiments, the embedded control circuit may include one or more peripheral modules 730. For example, as illustrated in FIG. 7, peripheral modules 730-1 through 730-n are provided.

As shown in FIG. 7, the circuit system 740 is connected to the eSPI slave module 710, and the eSPI slave module 710 communicates with the host processor through the eSPI protocol. The eSPI slave module 710, the processor 720, and the peripheral modules 730 are connected via a bus matrix 750, and in the embodiments, an AHB bus is used as the bus matrix. The buses between the eSPI slave module 710, the processor 720, and the peripheral modules 730 in the embodiments may include data lines, control lines, and address lines.

In the embodiments, the circuit system 740 accesses the peripheral modules 730 via the bus matrix 750. On the AHB bus between the circuit system 740 and the peripheral modules 730, the circuit system 740 serves as a master device (master) on the AHB bus, the peripheral modules 730 serve as slave devices on the AHB bus, and the peripheral modules 730 respond to various bus commands from the circuit system 740.

In the embodiments, the processor 720 accesses the peripheral modules 730 via the bus matrix 750. On the AHB bus between the processor 720 and the peripheral modules 730, the processor 720 serves as a master device (master) on the AHB bus, the peripheral modules 730 serve as slave devices (slaves) on the AHB bus, and the peripheral modules 730 respond to various bus commands from the processor 720.

In the embodiments, the processor 720 accesses the circuit system 740 via the bus matrix 750. On the AHB bus between the processor 720 and the circuit system 740, the processor 720 serves as a master device (master) on the AHB bus, the circuit system 740 serves as a slave device (slave) on the AHB bus, and the circuit system 740 responds to various bus commands from the processor 720. In an embodiment, the processor 720 accesses the circuit system 740 via the bus matrix 750 to configure an access permission for the circuit system 740 to access the peripheral modules 730. In another embodiment, the processor 720 accesses the circuit system 740 via the bus matrix 750 to transmit interrupt information about the peripheral modules 730 to the host processor.

In the embodiments, an interrupt signal line 760 is connected between the processor 720 and the circuit system 740. The circuit system 740 is capable of transmitting an interrupt signal to the processor 720 via the interrupt signal line 760.

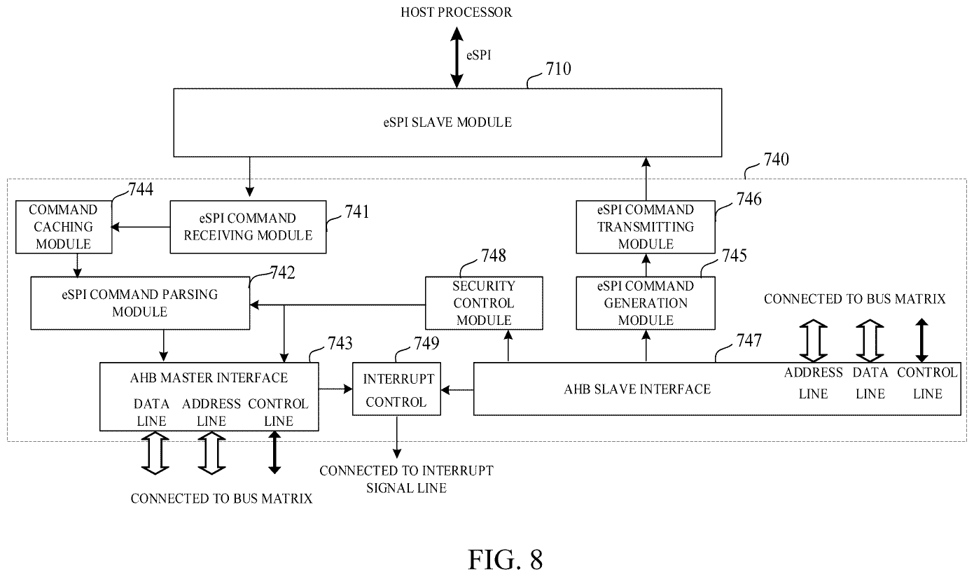

FIG. 8 illustrates a schematic block diagram of a circuit system 740 in some exemplary embodiments of the present disclosure. As shown in FIG. 8, the circuit system 740 includes: an eSPI command receiving module 741, configured to receive a bus command sent by the eSPI slave module 710; a command caching module 744, connected to the eSPI command receiving module 741 and configured to cache the received eSPI command; an eSPI command parsing module 742, connected to the eSPI command receiving module 741 and configured to parse the received eSPI command to obtain a destination address; and an AHB master interface 743, connected to the eSPI command parsing module 742 and configured to access the register of the peripheral module 730 corresponding to the destination address.

The eSPI command include a write command, the eSPI command parsing module 742 parses the eSPI command to also obtain target data, and the destination address is a to-be-written address. The AHB master interface 743 is configured to write the target data into the register of the peripheral module 730 corresponding to the destination address.

In some embodiments, an example of writing data into one of the peripheral modules 730 is illustrated below. The eSPI slave module 710 receives a write command from the host processor and transmits the write command to the eSPI command receiving module 741. The eSPI command receiving module 741 receives the write command and writes the write command into the command caching module 744. The eSPI command parsing circuit 742 obtains the write command from the command caching module 744 and parses the write command to obtain the destination address and the to-be-written data. The AHB master interface 743 writes the above data into the register of the peripheral module 730 corresponding to the destination address through the bus matrix 750.

As shown in FIG. 8, the circuit system 740 further includes: an eSPI command generation module 745, configured to generate an eSPI command; and an eSPI command transmitting module 746, connected to the eSPI command generation module 745 and configured to transmit the eSPI command generated by the eSPI command generation module 745 to the eSPI slave module 710 so that the generated eSPI command is received by the host processor.

The eSPI command includes a read command. The AHB master interface 743 is further configured to, after reading data, transmit the data read from the destination address to the eSPI command generation module 745 to cause the eSPI command generation module 745 to generate a corresponding eSPI command, and the eSPI command transmitting module 746 transmits the generated eSPI command to the eSPI slave module 710.

In some embodiments, an example of reading data from one of the peripheral modules 730 is illustrated as follows. After the AHB master interface 743 has read data from the destination address, the AHB master interface 743 transmits the read data to the eSPI command generation module 745. The eSPI command generation module 745 generates an eSPI command corresponding to the read command and transmits the eSPI command to the eSPI command transmitting module 746. The eSPI command transmitting module 746 transmits the eSPI command to the eSPI slave module 710. The eSPI slave module 710 transmits the eSPI command to the host processor so that the host processor receives the eSPI command to obtain the read data.

As shown in FIG. 8, the circuit system 740 further includes an AHB slave interface 747 configured to receive information sent by the processor 720 via the bus matrix 750. The AHB slave interface 747 is configured to receive interrupt information sent by the processor 720 via the bus matrix 750, and transmit the interrupt information to the eSPI command generation module 745 to cause the eSPI command generation module 745 to generate a corresponding eSPI command, and the eSPI command transmitting module 746 transmits the generated eSPI command to the eSPI slave module 710. Thereby, the interrupt information is sent to the host processor via the eSPI slave module 710.

In some embodiments, an example of the processor 720 transmitting interrupt information about one of the peripheral modules 730 to the host processor is illustrated below. The processor 720 detects interrupt information about the peripheral module 730. The processor 720 transmits the detected interrupt information to the eSPI command generation module 745 via the bus matrix. The eSPI command generation module 745 generates an eSPI command corresponding to the interrupt information. The eSPI command transmitting module 746 transmits the eSPI command generated by the eSPI command generating module 745 to the eSPI slave module 710. The eSPI slave module 710 transmits the eSPI command to the host processor so that the host processor receives the eSPI command to obtain the interrupt information. In some examples, after the host processor has obtained the interrupt information, the host processor responds to the embedded control circuit based on the interrupt information. In some examples, the host processor initiates, based on the interrupt information, a process of writing data into the register of the peripheral module 730 corresponding to the interrupt information. In some examples, the host processor initiates, based on the interrupt information, a process of reading data from the register of the peripheral module 730 corresponding to the interrupt information.

In some embodiments, the circuit system 740 further includes a security control module 748 connected to the AHB master interface 743 and the AHB slave interface 747. The security control module 748 is configured to provide permission information. The AHB master interface 743 is further configured to determine the permission to access a destination address based on the permission information in the security control module 748. In some embodiments, the AHB slave interface 747 is further configured to receive permission information sent by the processor 720 via the bus matrix 750, and write the permission information into the security control module 748. In the embodiments, each destination address may be configured to allow read and write access, allow read access and prohibit write access, or allow write access and prohibit read access, and the embodiments are not limited thereto.

In some embodiments, an example of writing data into one of the peripheral modules 730 under permission control is illustrated as follows. The bus interface circuit 710 receives a write command from the host processor and transmits the write command to the eSPI command receiving module 741. The eSPI command receiving module 741 receives the write command and the write command is cached to the command caching module 744. The eSPI command parsing module 742 obtains the write command from the command caching module 744, and parses the write command to obtain the destination address and the to-be-written data. The AHB master interface 743 may access the security control module 748, obtain permission information from the security control module 448, and determine, based on the permission information, whether the destination address is an address that allows write access. In the case where the destination address is an address that allows write access, the AHB master interface 743 writes the above data into the register of the peripheral module 730 corresponding to the destination address via the bus matrix 750. In the case where the destination address is an address that prohibits write access, the AHB master interface 743 transmits an interrupt signal to the processor 720 via the interrupt signal line 760 to cause the processor 720 to be notified that the host processor is requesting to write data into the address that prohibits write access.

In some embodiments, an example of reading data from one of the peripheral modules 730 under permission control is illustrated below. The eSPI slave module 710 receives a read command from the host processor and transmits the read command to the eSPI command receiving module 741. The eSPI command receiving module 741 receives the read command and caches the read command to the command caching module 744. The eSPI command parsing module 742 obtains the read command from the command caching module 744 and parses the read command to obtain a destination address. The AHB master interface 743 accesses the security control module 748, obtains permission information from the security control module 748, and determines, based on the permission information, whether the destination address is an address that allows read access. In the case where the destination address is an address that allows read access, the AHB master interface 743 reads data from the register of the peripheral module 730 corresponding to the destination address via the bus matrix 750. The AHB master interface 743 transmits the read data to the eSPI command generation module 745. The eSPI command generation module 745 generates an eSPI command corresponding to the read command and transmits the eSPI command to the eSPI command transmitting module 746. The eSPI command transmitting module 746 transmits the eSPI command to the eSPI slave module 710. The eSPI slave module 710 transmits the eSPI command to the host processor so that the host processor receives the eSPI command to obtain the read data. In the case where the destination address is an address that prohibits read access, the AHB master interface 743 transmits an interrupt signal to the processor 720 via the interrupt signal line 760 to cause the processor 720 to be notified that the host processor is requesting to read data from the address that prohibits read access.

As shown in FIGS. 7 and 8, the circuit system 740 further includes an interrupt control 749, and the interrupt control 749 is connected to the interrupt signal line 760 and is configured to transmit, in response to a command from the AHB master interface 743 and/or the AHB slave interface 747, an interrupt signal to the processor 720 via the interrupt signal line 760.

In some examples, an example of reading data from one of the peripheral modules based on eSPI is illustrated below. The processor 720 detects an interrupt about the peripheral module 730. In the case where an interrupt of the peripheral module 730 associated with the host processor is detected, the processor 720 writes the interrupt information into a shared register of the eSPI slave module 710 via the AHB slave interface 747. For example, the interrupt information includes an interrupt status and an interrupt identifier (ID). The eSPI slave module 710 receives the written information, and alarm is generated by pulling an IO pin low or through a dedicated Alert signal. The host processor receives the alarm signal and queries the cause of the alarm event using a GET_STATUS command. The eSPI slave module 710 receives the GET_STATUS command and transmits the interrupt information in the shared register to the host processor via an eSPI packet. The host processor determines the cause of the alarm based on the interrupt information, and the host processor initiates a GET_PC or GET_NP command to read the data. The eSPI slave module 710 receives the command, the circuit system 740 translates the command into a DMA operation, the data is read back from the register of the corresponding peripheral module 730, and the eSPI slave module 710 uploads the data to the host processor via an eSPI packet.

For example, in the case of a keyboard, when an operator presses the keyboard, a keyboard scanning module detects and holds the key code of a pressed key, and the keyboard scanning module transmits an interrupt to the processor 720. After the processor 720 queries and determines that the interrupt ID is from the keyboard scanning module and the cause of the interrupt (or the interrupt status) is that there is a key press operation by the operator, the processor 720 writes the interrupt ID and the interrupt status into the shared register of the eSPI slave module 710 via the AHB slave interface 747. After the eSPI slave module 710 has received the written information, alarm is generated by pulling an IO pin low or through a dedicated Alert signal. After the host processor has received the alarm signal, the host processor queries the cause of the alarm event using the GET_STATUS command. After the eSPI slave module 710 has received the GET_STATUS command, the eSPI slave module 710 transmits the interrupt ID and interrupt status in the shared register to the host processor via an eSPI packet. After obtaining the cause of the operator pressing the keyboard, the host processor initiates a GET_PC/NP command to read the key code of the key pressed by the operator. After the eSPI slave module 710 has received the command, the circuit system 740 translates the command into a DMA operation to read back the key code held by the keyboard scanning module, and the eSPI slave module 710 uploads an eSPI packet to the host processor.

In some examples, an example of writing data into one of the peripheral modules 730 based on eSPI is illustrated below. The host processor transmits a write command. The eSPI slave module 710 receives the write command, and the circuit system 740 obtains a write address and data from the write command, to write the data into the register of the peripheral module 730 corresponding to the write address.

For example, in the case of an ambient light, when the host processor is to transmit light effect data to the ambient light for display, the host processor first initiates a data write operation and transmits a write data packet, and the eSPI slave module 710 receives the packet. After the circuit system 740 has unpacked the packet and found that it is a write command to one of the registers of the ambient light, the write command is converted into a DMA operation, the data transmitted from the host processor is written into the specified address of the ambient light, and thus the ambient light changes its display state to accomplish the display effect required by the host processor. For example, the ambient light may generate interrupts during its operation in situations where such as there is no data to display (the data cache is empty) or there is an error in the display of the ambient light. When the ambient light (like the keyboard) generates an interrupt, the interrupt is transmitted to the processor 720, and then the processor 720 alerts the host processor via the eSPI slave module 710. The host processor queries the cause of the alert and reads the relevant data.

Embodiments of the present disclosure provide an embedded control circuit based on direct memory access and shared interfaces.

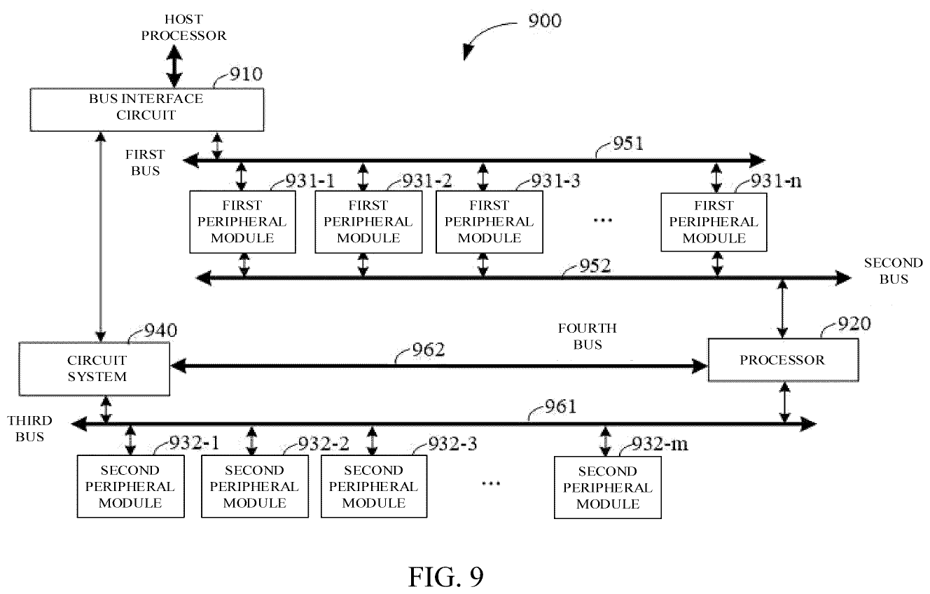

FIG. 9 illustrates a schematic block diagram of an embedded control circuit based on direct memory access and shared interfaces in some exemplary embodiments of the present disclosure. As shown in FIG. 9, the embedded control circuit 900 includes a bus interface circuit 910 for communicating with a host processor, a processor 920, one or more first peripheral modules 931, one or more second peripheral modules 932, a circuit system 940, a first bus 951, a second bus 952, and a third bus 961. Multiple first peripheral modules 931 are labelled 931-1 to 931-n in FIG. 9, and multiple second peripheral modules 932 are labelled 932-1 to 932-m in FIG. 9. It is to be understood that the embodiments do not limit the number of the first peripheral modules 931 and the number of the second peripheral modules 932, and the embedded control circuit 900 may include any number of first peripheral modules 931 and any number of second peripheral modules 932.

In some embodiments, the embedded control circuit 900 further includes a fourth bus 962 connected between the processor 920 and the circuit system 940 to transmit information between the processor 920 and the circuit system 940.

In some embodiments, the embedded control circuit 900 further includes an interrupt signal line, connected between the processor 920 and the circuit system 940. The interrupt signal line may be configured to transmit any interrupt signal between the processor 920 and the circuit system 940, which is not limited by the embodiments. In some embodiments, the circuit system 940 is configured to transmit an interrupt signal to the processor 920 via the interrupt signal line 980. Reference may be made to FIG. 4 and the description thereof, which is not be repeated in the embodiments.

Each of the first peripheral modules 931 includes a first interface and a second interface. The first bus 951 is connected between a first interface of each first peripheral module 931 and the bus interface circuit 910. The second bus 952 is connected between a second interface of each first peripheral module 931 and the processor 920. An I/O interface corresponding to each first peripheral module 931 is provided on the bus interface circuit 910. The bus interface circuit 910 is configured to access the first peripheral modules 931 via the first bus 951. The processor 920 is configured to access the first peripheral modules 931 via the second bus 952.

The third bus 961 is connected between the second peripheral modules 932 and the circuit system 940. The third bus 961 is further connected between the second peripheral modules 932 and the processor 920. The circuit system 940 is configured to communicate with the host processor through the bus interface circuit 910 and access the second peripheral modules 932 via the third bus 961 according to commands from the host processor. In the embodiments, the circuit system 940 serves as a master device on the third bus 961, the second peripheral modules 932 serve as slave devices on the third bus 961, and the second peripheral modules 932 can respond to various bus commands from the circuit system 940. The processor 920 accesses the second peripheral modules 932 via the third bus 961. In the embodiments, the processor 920 may serve as a master device on the third bus 961, the second peripheral modules 932 may serve as slave devices on the third bus 961, and the second peripheral modules 932 can respond to various bus commands from the processor 920.

In some embodiments, at least part of the first bus 951, the second bus 952, the third bus 961, and the fourth bus 962 may utilize a bus matrix, and at least part of the bus interface circuit 910, the processor 920, the first peripheral module 931, the second peripheral module 932, and the circuit system 940 are accessible to each other via a bus matrix.

In the embodiments, for the details of the first peripheral module 931, one may refer to the description of FIGS. 1, 2, and 3 of the present disclosure and that will not be repeated herein. In the embodiments, for the details of the circuit system 940 and the second peripheral module 932, one may refer to the description of FIGS. 4, 6, 7, and 8 of the present disclosure and that will not be repeated herein.

In the embodiments, the host processor may access the first peripheral modules 931 via the bus interface circuit 910 and the first bus 951. The host processor may also access the second peripheral modules 932 via the bus interface circuit 910, the circuit system 940, and the third bus 961. The following embodiments describe the embedded control circuit 900 and distinguish between the host processor's access to the first peripheral modules 931 and to the second peripheral modules 932.

In some embodiments, the bus interface circuit 910 is configured to: determine, based on the accessed destination address, whether the host processor accesses one of the first peripheral modules 931 or one of the second peripheral modules 932; access, in the case where the host processor accesses the first peripheral module 931, the first peripheral module 931 via the first bus 951; forward, in the case where the host processor accesses the second peripheral module 932, an access command from the host processor to the circuit system 940, such that the circuit system 940 accesses the second peripheral module 932 via the third bus 961 according to commands from the host processor.

In some embodiments, the circuit system 940 is configured to: determine, based on the accessed destination address, whether the host processor accesses one of the second peripheral modules 932; and access, in the case where the host processor accesses the second peripheral module 932, the second peripheral module 932 via the third bus 961 based on the command from the host processor.

In some embodiments, each first peripheral module 931 is configured to: determine, based on the accessed destination address, whether the host processor accesses the first peripheral module 931 itself; and respond to, in the case where the host processor accesses the first peripheral module 931 itself, the access from the host processor.

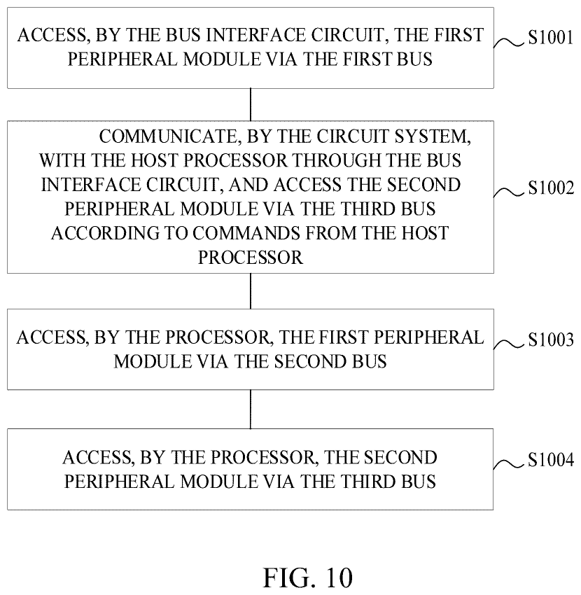

FIG. 10 illustrates a flowchart of a peripheral access method based on direct memory access and shared interfaces in some exemplary embodiments of the present disclosure, applied to the embedded control circuit 900 shown in FIG. 9. The peripheral access method includes steps S1001 to S1004. It is to be understood that, although the step numbers are labelled in FIG. 10, the present embodiments do not limit the order of steps S1001 to S1004.

At step S1001, the bus interface circuit 910 accesses one of the peripheral modules 931 via the first bus 951. In the embodiments, the accessing of the first peripheral module 931 by the bus interface circuit 910 via the first bus 951 includes reading and/or writing of the register of the first peripheral module 931. In the embodiments, the first bus 951 is connected between the bus interface circuit 910 and a first interface of the first peripheral module 931, and the bus interface circuit 910 accesses the register of the first peripheral module 931 via the first bus 951 and the first interface of the first peripheral module 931.

In some embodiments, at step S1001, the bus interface circuit 910 receives a write command from the host processor and writes data into the register of the first peripheral module 931 corresponding to the write command via the first bus 951. The bus interface circuit 910 may also receive a read command from the host processor and read data from the register of the first peripheral module 931 corresponding to the read command via the first bus 951.

At step S1002, the circuit system 940 communicates with the host processor through the bus interface circuit 910 and accesses the second peripheral module 932 via the third bus 961 according to commands from the host processor.

In some embodiments, at step S1002, the circuit system 940 receives a write command from the host processor through the bus interface circuit 910, and writes, based on the write command, data into the register of the second peripheral module 932 corresponding to the write command via the third bus 961. The circuit system 940 may also receive a read command from the host processor through the bus interface circuit 910, and read, based on the read command, data from the register of the second peripheral module 932 corresponding to the read command via the third bus 961.

In some embodiments, the circuit system 940 accesses one of the second peripheral modules 932 based on preset permissions. In the embodiments, each destination address may be configured to allow read and write access, allow read access and prohibit write access, or allow write access and prohibit read access, and the embodiments are not limited thereto. In some embodiments, the processor 920 configures, via the fourth bus 962 connected between the processor 920 and the circuit system 940, the permission for the circuit system 940 to access the second peripheral module 932. The circuit system 940 accesses the second peripheral module 932 based on the permission information configured by the processor 920.

In some embodiments, an example of writing data into the second peripheral module 932 under permission control is illustrated as follows. The bus interface circuit 910 receives a write command from the host processor and transmits the write command to the circuit system 940. The circuit system 940 receives the write command and parses the write command to obtain a destination address and to-be-written data. The circuit system 940 determines whether the destination address is an address that allows write access, and in the case where the destination address is an address that allows write access, the circuit system 940 writes the above data into the register of the second peripheral module 932 corresponding to the destination address via the third bus 961. In some examples, in the case where the destination address is an address that prohibits write access, the circuit system 940 transmits an interrupt signal to the processor 920 via an interrupt signal line between the circuit system 940 and the processor 920 to notify the processor 920 that the host processor is requesting access to the register that prohibits write access.

In some embodiments, an example of reading data from the second peripheral module 932 under permission control is illustrated as follows. The bus interface circuit 910 receives a read command from the host processor and transmits the read command to the circuit system 940. The circuit system 940 receives the read command and parses the read command to obtain a destination address. The circuit system 940 determines whether the destination address is an address that allows read access. In the case where the destination address is an address that allows read access, the circuit system 940 reads data from the register of the second peripheral module 932 corresponding to the destination address via the third bus 961. After the circuit system 940 has read the data, the circuit system 940 generates a bus command corresponding to the read command and transmits the bus command to the bus interface circuit 910. The bus interface circuit 910 transmits the bus command to the host processor so that the host processor receives the bus command to obtain the read data. In some examples, in the case where the destination address is an address that prohibits read access, the circuit system 940 transmits an interrupt signal to the processor 920 via an interrupt signal line between the circuit system 940 and the processor 920 to notify the processor 920 that the host processor is requesting access to the register that prohibits read access.

At step S1003, the processor 920 accesses the first peripheral module 931 via the second bus 952. In the embodiments, the processor 920 reads data from the register of the first peripheral module 931 via the second bus 952. The processor 920 may also write data into the register of the first peripheral module 931 via the second bus 952.

At step S1004, the processor 920 accesses the second peripheral module 932 via the third bus 961. In some examples, accessing of the second peripheral module 932 by the processor 920 via the third bus 961 may include reading and/or writing of the register of the second peripheral module 932 by the processor 920 via the third bus 961.

In some embodiments, interrupt information about the second peripheral module 932 is sent by the processor 920 to the circuit system 940 via the bus between the processor 920 and the circuit system 940. The circuit system 940 transmits the interrupt information to the host processor through the bus interface circuit 910.

In some embodiments, an example of the processor 920 transmitting interrupt information about the second peripheral module 932 to the host processor is illustrated below. The processor 920 detects the interrupt information of the second peripheral module 932. The processor 920 transmits the detected interrupt information to the circuit system 940 via the bus between the processor 920 and the circuit system 940. The circuit system 940 generates a bus command corresponding to the interrupt information and transmits the generated bus command to the bus interface circuit 910. The bus interface circuit 910 transmits the bus command to the host processor so that the host processor receives the bus command to obtain the interrupt information. In some examples, after the host processor has obtained the interrupt information, the host processor responds to the embedded control circuit based on the interrupt information. In some examples, the host processor initiates, based on the interrupt information, a process of writing data into the register of the peripheral module 932 corresponding to the interrupt information. In some examples, the host processor initiates, based on the interrupt information, a process of reading data from the register of the peripheral module 932 corresponding to the interrupt information.

The following is a description of an embedded control circuit based on direct memory access and shared interfaces in some exemplary embodiments of the present disclosure, and the host processor communicates with the embedded control circuit via an eSPI bus.

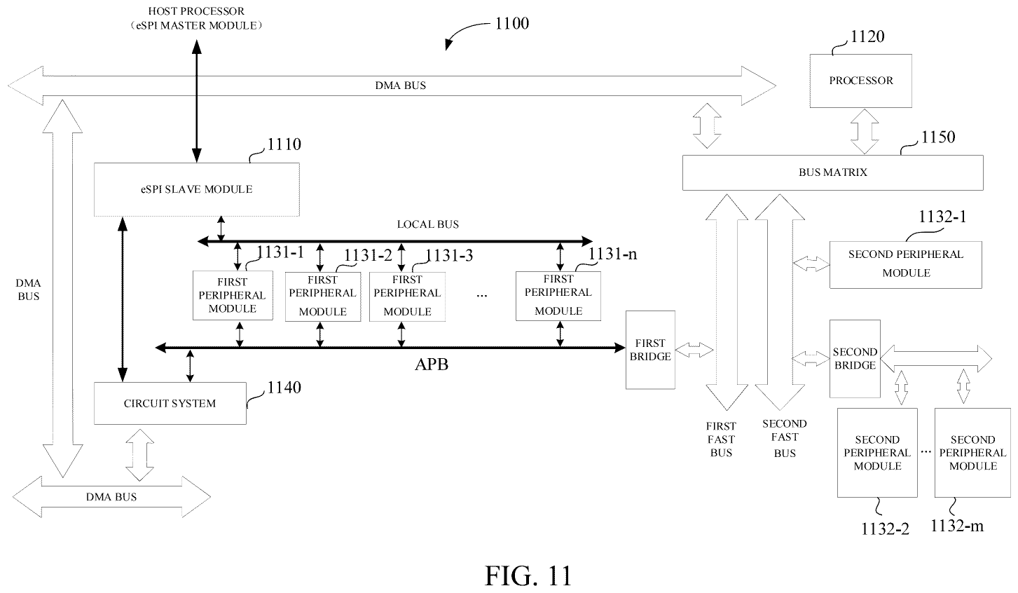

FIG. 11 illustrates a schematic block diagram of an embedded control circuit based on direct memory access and shared interfaces and using an eSPI bus in some exemplary embodiments of the present disclosure. As shown in FIG. 11, the embedded control circuit 1100 includes an eSPI slave module 1110 for communicating with a host processor, a processor 1120, one or more first peripheral modules 1131, one or more second peripheral modules 1132, a circuit system 1140, and a bus matrix 1150. Multiple first peripheral modules 1131 are labelled 1131-1 to 1131-n in FIG. 11, and multiple second peripheral modules 1132 are labelled 1132-1 to 1132-m in FIG. 11. The bus matrix is used in the present embodiments, and the present embodiments are described below in connection with FIG. 11.

Each of the first peripheral modules 1131 includes a first interface and a second interface. A local bus is connected between a first interface of each first peripheral module 1131 and the eSPI slave module 1110. A second interface of each first peripheral module 1131 is connected to an APB bus, the processor 1120 is connected to the bus matrix 1150, the APB bus is connected to the bus matrix via a first bridge and a first fast bus, and thereby the second interface of each first peripheral module 1131 is connected to the processor 1120. The eSPI slave module 1110 is configured to access the first peripheral modules 1131 via the local bus. The processor 1120 is configured to access the first peripheral modules 1131 via the bus matrix, the first fast bus, the first bridge, and the APB bus.

The circuit system 1140 is connected to a DMA bus, the DMA bus is connected to the bus matrix 1150, the second peripheral modules 1132 are connected to a second fast bus, the second fast bus is connected to the bus matrix, and thus the second peripheral modules 1132 are connected to the circuit system 1140 via the DMA bus, the bus matrix 1150, and the second fast bus. The processor 1120 is connected to the bus matrix and the second peripheral modules 1132 are connected to the processor 1120 via the bus matrix 1150 and the second fast bus. The circuit system 1140 is configured to communicate with the host processor via the eSPI slave module 1110 and access the second peripheral modules 1132 via the DMA bus, the bus matrix 1150, and the second fast bus according to commands from the host processor. In the embodiments, the circuit system 1140 serves as a master device, the second peripheral modules 1132 serve as slave devices, and the second peripheral modules 1132 can respond to various bus commands from the circuit system 1140. The processor 1120 accesses the second peripheral modules 1132 via the bus matrix 1150 and the second fast bus. In the embodiments, the processor 1120 may serve as a master device, the second peripheral modules 1132 may serve as slave devices, and the second peripheral modules 1132 can respond to various bus commands from the processor 1120.

In the embodiments, some second peripheral modules 1132, such as the second peripheral module 1132-1 shown in FIG. 11, may be directly connected to the second fast bus, and examples of the second peripheral module 1132-1 may include PD/Type-C interfaces. Some second peripheral modules 1132, such as the second peripheral modules 1132-2 to 1132-m shown in FIG. 11, may be connected to the second fast bus via a second bridge, and examples of the second peripheral modules 1132-2 to 1132-m may include an ambient light control module and a breathing light control module. It is to be understood that the embodiments do not limit whether the second peripheral modules 1132 are connected to the second fast bus via a bridge.

In the embodiments, for the details of the first peripheral modules 1131, one may refer to the description of FIGS. 1, 2, and 3 of the present disclosure and that will not be repeated herein. In the embodiments, for the details of the circuit system 1140 and the second peripheral module 1132, one may refer to the description of FIGS. 4, 6, 7, and 8 of the present disclosure and that will not be repeated herein.

In this embodiment, the host processor may access the first peripheral modules 1131 via the eSPI slave module 1110 and the local bus. The host processor may also access the second peripheral modules 1132 via the eSPI slave module 1110, the circuit system 1140, the DMA bus, the bus matrix 1150, and the second fast bus. The following embodiments describe the embedded control circuit 1100 and distinguish between the host processor's access to the first peripheral modules 1131 and to the second peripheral modules 1132.

In some embodiments, the eSPI slave module 1110 is configured to: determine, based on the accessed destination address, whether the host processor accesses one of the first peripheral modules 1131 or one of the second peripheral modules 1132; access, in the case where the host processor accesses the first peripheral module 1131, the first peripheral module 1131 via the local bus; forward, in the case where the host processor accesses the second peripheral module 1132, an access command from the host processor to the circuit system 1140, such that the circuit system 1140 accesses the second peripheral module 1132 via the DMA bus, the bus matrix 1150, and the second fast bus according to access commands from the host processor.

In some embodiments, the circuit system 1140 is configured to: determine, based on the accessed destination address, whether the host processor accesses the second peripheral module 1132; and access, in the case where the host processor accesses the second peripheral module 1132, the second peripheral module 1132 via the DMA bus, the bus matrix 1150, and the second fast bus according to commands from the host processor.

In some embodiments, each first peripheral module 1131 is configured to: determine, based on the accessed destination address, whether the host processor accesses the first peripheral module itself; and respond to, in the case where the host processor accesses the first peripheral module itself, an access from the host processor.

Embodiments of the present disclosure provide an embedded control circuit using dual bus interfaces.

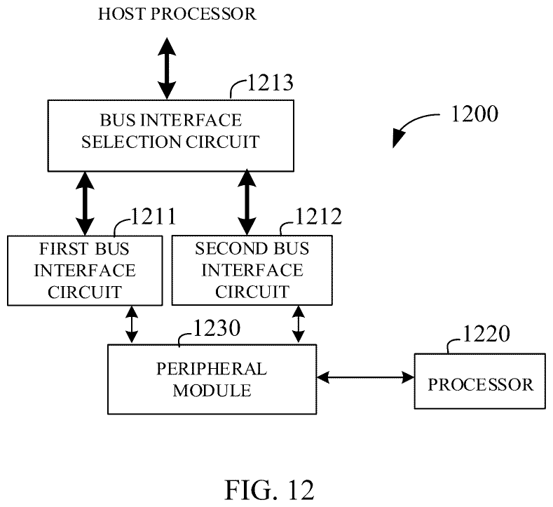

FIG. 12 illustrates a schematic block diagram of an embedded control circuit using dual bus interfaces in some exemplary embodiments of the present disclosure. As shown in FIG. 12, the embedded control circuit 1200 includes: one or more peripheral modules 1230; a processor 1220, connected to the one or more peripheral modules 1230; a first bus interface circuit 1211, connected to the one or more peripheral modules 1230; a second bus interface circuit 1212, connected to the one or more peripheral modules 1230; and a bus interface selection circuit 1213, configured to communicate with the host processor and operable to connect the first bus interface circuit 1211 or the second bus interface circuit 1212 to the host processor.

In the embodiments, the first bus interface circuit 1211 and the second bus interface circuit 1212 may use various types of bus interfaces to communicate with the host processor, including, but are not limited to, an LPC bus, an SPI bus, an eSPI bus, and so on. For example, the first bus interface circuit 1211 may be an LPC circuit, the second bus interface circuit 1212 may be an eSPI circuit, and thus the embedded control circuit 1200 may communicate with the host processor via an LPC bus protocol or an eSPI bus protocol. It is to be understood that the first bus interface circuit 1211 and the second bus interface circuit 1212 may use a combination of any two bus protocols, which is not limited by the embodiments.

In some embodiment, the bus interface selection circuit 1213 is configured to connect the first bus interface circuit 1211 or the second bus interface circuit 1212 to the host processor based on an initialization configuration. After initialization configuration, the embedded control circuit 1200 is configured such that one of the first bus interface circuit 1211 and the second bus interface circuit 1212 communicates with the host processor. The bus interface selection circuit 1213 connects one of the first bus interface circuit 1211 and the second bus interface circuit 1212 to the host processor based on the initialization configuration, thereby causing the configured bus interface circuit to communicate with the host processor.

In some embodiments, the peripheral module(s) 1230 include one or more first peripheral modules, and each of the one or more first peripheral modules includes a first interface and a second interface. The first interface of each first peripheral module is connected to the first bus interface circuit and the second bus interface circuit via a first bus, and the second interface of each first peripheral module is connected to the processor via a second bus. The first bus interface circuit 1211 and the second bus interface circuit 1212 are configured to access the one or more first peripheral modules via the first bus. The processor 1220 is configured to access the one or more first peripheral modules via the second bus.

In the embodiments, for the details of the first peripheral module, one may refer to the description of FIGS. 1, 2, and 3 of the present disclosure and that will not be repeated herein.

In some embodiments, the peripheral module(s) 1230 include one or more second peripheral modules. The embedded control circuit further includes a circuit system. The one or more second peripheral modules are connected to the circuit system via a third bus. The one or more second peripheral modules are connected to the processor 1120 via the third bus. The circuit system is configured to communicate with the host processor via the first bus interface circuit 1211 or the second bus interface circuit 1212 and access the one or more second peripheral modules via the third bus based on commands from the host processor. The processor 1220 is configured to access the one or more second peripheral modules via the third bus.

In the embodiments, for the details of the circuit system and the second peripheral module, one may refer to the description of FIGS. 4, 6, 7, and 8 of the present disclosure and that will not be repeated herein.

In some embodiments, the peripheral modules 1230 include one or more first peripheral modules and one or more second peripheral modules. In the embodiments, the host processor may access the first peripheral module(s) via the first bus interface circuit 1211 or the second bus interface circuit 1212 and via the first bus. The host processor may also access the second peripheral module(s) via the first bus interface circuit 1211 or the second bus interface circuit 1212 and via the circuit system and the third bus. The following embodiments describe the embedded control circuit 1200 and distinguish between the host processor's access to the first peripheral module and the second peripheral module.

In some embodiments, the first bus interface circuit 1211 and/or the second bus interface circuit 1212 is configured to: determine, based on the accessed destination address, whether the host processor accesses the first peripheral module(s) or the second peripheral module(s); access, in the case where the host processor accesses one or more first peripheral modules, the one or more first peripheral modules via the first bus; forward, in the case where the host processor accesses one or more second peripheral modules, an access command from the host processor to the circuit system. The circuit system accesses the second peripheral module via the third bus.

In some embodiments, the circuit system is configured to: determine, based on the accessed destination address, whether the host processor accesses one or more second peripheral modules; and access, in the case where the host processor accesses one or more second peripheral modules, the one or more second peripheral modules via the third bus according to the command from the host processor.

The following is a description of an embedded control circuit in some exemplary embodiments of the present disclosure, where an LPC bus and an eSPI bus are used as an example, and the host processor communicates with the embedded control circuit via the eSPI bus or the LPC bus.

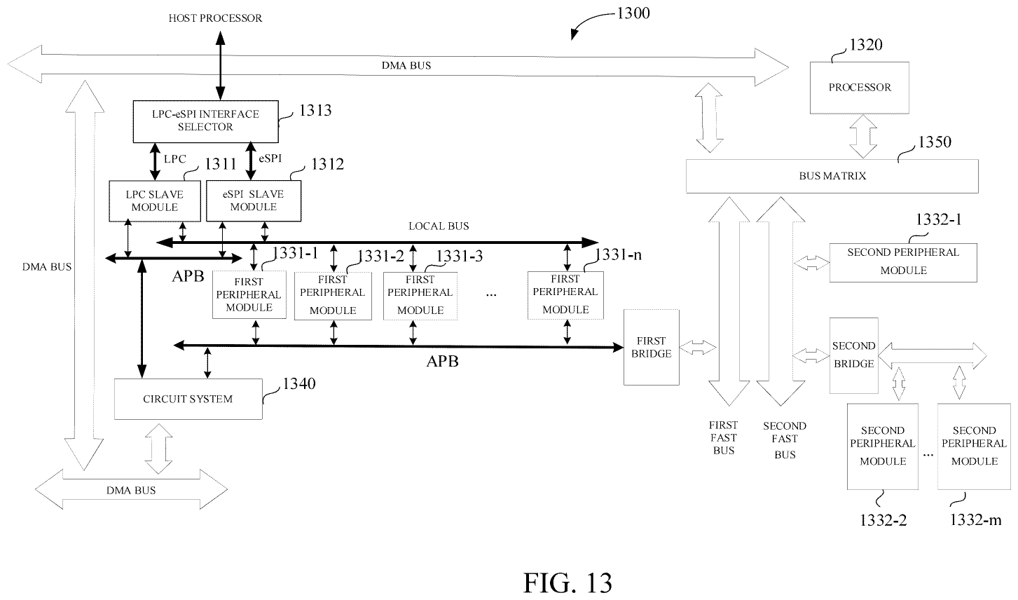

FIG. 13 illustrates a schematic block diagram of an embedded control circuit using LPC-eSPI dual bus interfaces in some exemplary embodiments of the present disclosure. As shown in FIG. 13, the embedded control circuit 1300 includes: peripheral modules; a processor 1320, connected to the peripheral modules; an LPC slave module 1311, connected to one or more peripheral modules; an eSPI slave module 1312, connected to one or more peripheral modules; an LPC-eSPI interface selector 1313, configured to communicate with a host processor and operable to connect the LPC slave module 1311 or the eSPI slave module 1312 to the host processor; and a circuit system 1340. The peripheral modules include one or more first peripheral modules 1331 and one or more second peripheral modules 1332. The first peripheral modules are labelled 1331-1 to 1331-n in FIG. 13, and the second peripheral modules are labelled 1332-1 to 1332-m in FIG. 11.

In some embodiments, the LPC-eSPI interface selector 1313 is configured to connect the LPC slave module 1311 or the eSPI slave module 1312 to the host processor based on an initialization configuration. After initialization configuration, the embedded control circuit 1300 is configured such that one bus interface circuit of the LPC slave module 1311 and the eSPI slave module 1312 communicates with the host processor. The LPC-eSPI interface selector 1313 connects one bus interface circuit of the LPC slave module 1311 and the eSPI slave module 1312 to the host processor based on the initialization configuration, thereby causing the configured bus interface circuit to communicate with the host processor.

Each of the first peripheral modules 1131 includes a first interface and a second interface. The first interface of each first peripheral module 1331 is connected to the LPC slave module 1311 and the eSPI slave module 1312 via a local bus. The second interface of each first peripheral module 1331 is connected to the processor via an APB bus, a first bridge, a first fast bus, and a bus matrix 1350. The LPC slave module 1311 and the eSPI slave module 1312 access the one or more first peripheral modules 1331 via the local bus. The processor 1320 accesses the first peripheral module(s) 1331 via the bus matrix 1350, the first fast bus, the first bridge, and the APB bus.

In the embodiments, for the details of the first peripheral modules 1331, one may refer to the description of FIGS. 1, 2, and 3 of the present disclosure and that will not be repeated herein.

In the embodiments, the second peripheral modules 1332 are connected to the circuit system 1340 via a DMA bus, the bus matrix 1350, and a second fast bus. The second peripheral modules 1332 are connected to the processor 1320 via the bus matrix 1350 and the second fast bus. The circuit system 1340 communicates with the host processor via the LPC slave module 1311 or the eSPI slave module 1312 and accesses the second peripheral modules 1332 via the DMA bus, the bus matrix, and the second fast bus according to commands from the host processor. The processor 1320 accesses the second peripheral modules 1332 via the bus matrix 1350 and the second fast bus.

In some embodiments, the processor 1320 may also access the circuit system 1340 via the bus matrix 1350, the first bridge and the APB bus. Information may be transmitted between the processor 1320 and the circuit system 1340 via the bus matrix 1350, the first bridge, and the APB bus, for example, the processor 1320 may transmit permission information for accessing the second peripheral modules 1332 to the circuit system 1340 via these lines.

In the embodiments, for the details of the circuit system 1340 and the second peripheral modules 1332, one may refer to the description of FIGS. 4, 6, 7, and 8 of the present disclosure and that will not be repeated herein.

In the embodiments, the host processor may access the first peripheral modules 1331 via the LPC slave module 1311 or the eSPI slave module 1312 and via the local bus. The host processor may also access the second peripheral module 1332 via the LPC slave module 1311 or the eSPI slave module 1312 and via the circuit system 1340, the DMA bus, the bus matrix 1350, and the second fast bus. The following embodiments describe the embedded control circuit 1300 and distinguish between the host processor's access to the first peripheral module(s) 1331 and to the second peripheral module(s) 1332.

In some embodiments, the LPC slave module 1311 and/or the eSPI slave module 1312 is configured to: determine, based on the accessed destination address, whether the host processor accesses the first peripheral module(s) 1331 or the second peripheral module(s) 1332; access, in the case where the host processor accesses one or more first peripheral modules 1331, the one or more first peripheral modules 1331 via the first bus; forward, in the case where the host processor accesses one or more second peripheral modules 1332, an access command from the host processor to the circuit system 1340. The circuit system 1340 accesses the second peripheral module(s) 1332 via the DMA bus, the bus matrix 1350, and the second fast bus.

In some embodiments, the circuit system 1340 is configured to: determine, based on the accessed destination address, whether the host processor accesses one or more second peripheral modules 1332; and access, in the case where the host processor accesses one or more second peripheral modules 1332, the one or more second peripheral modules 1332 via the DMA bus, the bus matrix 1350, and the second fast bus according to commands from the host processor.

In some embodiments, each first peripheral module 1331 is configured to: determine, based on the accessed destination address, whether the host processor accesses the first peripheral module itself; and respond to, in the case where the host processor accesses the first peripheral module itself, the access from the host processor.

Exemplary embodiments of the present disclosure also provide a chip, and the chip may include the embedded control circuit aforementioned in the present disclosure.

The embodiments of the present disclosure may be integrated into an electronic device, and the electronic device is selected from the group consisting of: a set-top box; an entertainment unit; a navigation device; a communication device; a fixed location data unit; a mobile location data unit; a global positioning system (GPS) device; a mobile phone; a cellular telephone; a smart telephone; a session initiation protocol (SIP) telephone; a tablet computer; a tablet cellular phone; a server; a computer; a portable computer; a mobile computing device; a wearable computing device; a desktop computer; a personal digital assistant (PDA); a monitor; a computer monitor; a television; a tuner; a radio receiver; a satellite radio; a music player; a digital music player; a portable music player; a digital video player; a video player; a digital video disc (DVD) player; a portable digital video player; a motor vehicle; a vehicle component; an avionics system; an unmanned aircraft; and a multi-rotor vehicle.

What is claimed is:

1. An embedded control circuit, comprising:
a bus interface circuit for communicating with a host processor;
a processor;
one or more peripheral modules;
a circuit system connected to the bus interface circuit;
a first bus connected between the one or more peripheral modules and the circuit system; and
a second bus connected between the one or more peripheral modules and the processor;
wherein the circuit system is configured to: communicate with the host processor through the bus interface circuit, and access the one or more peripheral modules via the first bus according to a command from the host processor; and
the processor is configured to access the one or more peripheral modules via the second bus.

2. The embedded control circuit according to claim 1, further comprising a third bus connected between the processor and the circuit system.

3. The embedded control circuit according to claim 2, wherein the processor is configured to transmit interrupt information about the one or more peripheral modules to the circuit system via the third bus, and the circuit system is configured to transmit the interrupt information to the host processor through the bus interface circuit.

4. The embedded control circuit according to claim 2, wherein the processor is configured to configure, via the third bus, a permission for the circuit system to access the one or more peripheral modules.

5. The embedded control circuit according to claim 1, wherein the circuit system is configured to access the one or more peripheral modules based on preset permissions.

6. The embedded control circuit according to claim 1, further comprising an interrupt signal line connected between the processor and the circuit system.

7. The embedded control circuit according to claim 6, wherein the circuit system is configured to transmit an interrupt signal to the processor via the interrupt signal line.

8. The embedded control circuit according to claim 7, wherein the circuit system is configured to transmit the interrupt signal to the processor via the interrupt signal line under a condition that a register of one of the one or more peripheral modules that is accessed by the host processor is configured to prohibit access.

9. The embedded control circuit according to claim 1, wherein the circuit system is configured to:
receive a write command from the host processor through the bus interface circuit and write, based on the write command, data into a register of one of the one or more peripheral modules that corresponds to the write command via the first bus; and/or
receive a read command from the host processor through the bus interface circuit and read, based on the read command, data from a register of one of the one or more peripheral modules that corresponds to the read command via the first bus.

10. The embedded control circuit according to claim 2, wherein the circuit system comprises:
a receive circuit configured to receive a bus command sent by the bus interface circuit;
a parse circuit configured to parse the received bus command to obtain a destination address; and
a first controller configured to access a register of one of the one or more peripheral modules that corresponds to the destination address.

11. The embedded control circuit according to claim 10, wherein under a condition that the bus command is a write command, the parse circuit further obtains target data; and
wherein the first controller is configured to write the target data into the register of the peripheral module that corresponds to the destination address.

12. The embedded control circuit according to claim 10, wherein the circuit system further comprises:
a generation circuit configured to generate a bus command; and
a transmit circuit configured to transmit the generated bus command to the bus interface circuit to cause the generated bus command to be received by the host processor.

13. The embedded control circuit according to claim 12, wherein the first controller is further configured to: transmit data read from the destination address to the generation circuit to cause the generation circuit to generate the bus command corresponding to the data and cause the transmit circuit to transmit the generated bus command to the bus interface circuit.

14. The embedded control circuit according to claim 12, wherein the circuit system further comprises a second controller configured to receive information sent by the processor via the third bus.

15. The embedded control circuit according to claim 14, wherein the second controller is further configured to receive interrupt information sent by the processor via the third bus, and transmit the interrupt information to the generation circuit to cause the generation circuit to generate the bus command corresponding to the interrupt information and cause the transmit circuit to transmit the generated bus command to the bus interface circuit.

16. The embedded control circuit according to claim 14, wherein the circuit system further comprises a security control module connected to the first controller and to the second controller;
the second controller is further configured to receive permission information sent by the processor via the third bus and write the permission information into the security control module; and
the first controller is further configured to determine a permission to access the destination address based on the permission information in the security control module.

17. The embedded control circuit according to claim 1, wherein the bus interface circuit comprises one or more bus interfaces.

18. The embedded control circuit according to claim 1, wherein the circuit system comprises:
a receive circuit configured to receive a bus command sent by the bus interface circuit;
a parse circuit configured to parse the received bus command to obtain a destination address; and
a first controller configured to access a register of one of the one or more peripheral modules that corresponds to the destination address.

19. A peripheral access method applied to an embedded control circuit, the embedded control circuit comprising a bus interface circuit, a processor, one or more peripheral modules, and a circuit system, wherein the peripheral access method comprises:
communicating, by the circuit system, with a host processor through the bus interface circuit, and accessing the one or more peripheral modules via a first bus according to a command from the host processor, wherein the first bus is connected between the one or more peripheral modules and the circuit system; and
accessing, by the processor, the one or more peripheral modules via a second bus, wherein the second bus is connected between the one or more peripheral modules and the processor.

20. An electronic device, comprising: an embedded control circuit and a host processor;
wherein the embedded control circuit comprises:
a bus interface circuit for communicating with the host processor;
a processor;
one or more peripheral modules;
a circuit system connected to the bus interface circuit;
a first bus connected between the one or more peripheral modules and the circuit system; and
a second bus connected between the one or more peripheral modules and the processor;
wherein the circuit system is configured to: communicate with the host processor through the bus interface circuit, and access the one or more peripheral modules via the first bus according to a command from the host processor; and
the processor is configured to access the one or more peripheral modules via the second bus.
